(19) United States
(12) Patent Application Publication
(10) Pub. No.: US 2026/0107176 A1
(43) Pub. Date: Apr. 16, 2026

(54) LEARNING BASED CSI REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/340,847

(22) Filed: Sep. 25, 2025

Related U.S. Application Data
(60) Provisional application No. 63/706,447, filed on Oct. 11, 2024.
(60) Provisional application No. 63/746,629, filed on Jan. 17, 2025.

(51) Int. Cl. H04W 24/10; H04B 7/06

(52) U.S. Cl. CPC H04W 24/10; H04B 7/0626

(57) ABSTRACT

Apparatuses and methods for learning based channel state information (CSI) reporting. A method performed by a user equipment (UE) includes receiving information about a basis, identifying the basis, determining a CSI report based on the basis, and transmitting the CSI report. The basis is a trained basis when the UE is capable of supporting the trained basis or a fixed discrete Fourier transform (DFT) basis when the UE is not capable of supporting the trained basis. The trained basis is trained using data. The basis, the data, and the CSI report are associated with P ports and N_{SB} subbands (SBs), where P and N_{SB} are greater than 1.

### CROSS-REFERENCE TO RELATED AND CLAIM OF PRIORITY

The present application claims priority under 35 U.S.C. § 119 (e) to U.S. Provisional Patent Application No. 63/706,447 filed on Oct. 11, 2024 and U.S. Provisional Patent Application No. 63/746,629 filed on Jan. 17, 2025, which are hereby incorporated by reference in their entirety.

### TECHNICAL FIELD

The present disclosure relates generally to wireless communication systems and, more specifically, the present disclosure is related to apparatuses and methods for learning based channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to learning based CSI reporting.

In one embodiment, a user equipment (UE) is provided. The UE includes a transceiver configured to receive information about a basis. The basis is a trained basis when the UE is capable of supporting the trained basis or a fixed discrete Fourier transform (DFT) basis when the UE is not capable of supporting the trained basis. The UE further includes a processor operably coupled to the transceiver. The processor is configured to identify the basis, and determine a CSI report based on the basis. The transceiver is further configured to transmit the CSI report. The trained basis is trained using data. The basis, the data, and the CSI report are associated with P ports and N_{SB} subbands (SBs), where P and N_{SB} are greater than 1.

In another embodiment, a base station (BS) is provided. The BS includes a processor and a transceiver operably coupled to the transceiver. The processor is configured to transmit information about a basis to a UE and receive a CSI report based on the basis. The basis is a trained basis when the UE is capable of supporting the trained basis or a fixed DFT basis when the UE is not capable of supporting the trained basis. The trained basis is trained using data. The basis, the data, and the CSI report are associated with P ports and N_{SB} SBs, where P and N_{SB} are greater than 1.

In yet another embodiment, a method performed by a UE is provided. The method includes receiving information about a basis, identifying the basis, determining a CSI report based on the basis, and transmitting the CSI report. The basis is a trained basis when the UE is capable of supporting the trained basis or a fixed DFT basis when the UE is not capable of supporting the trained basis. The trained basis is trained using data. The basis, the data, and the CSI report are associated with P ports and N_{SB} SBs, where P and N_{SB} are greater than 1.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates example radio access network (RAN) configurations according to embodiments of the present disclosure;

FIG. 7 illustrates an example convolutional neural network (CNN) according to embodiments of the present disclosure;

FIG. 8 illustrates an example antenna port layout according to embodiments of the present disclosure;

FIG. 9 illustrates a timeline of example spatial-domain (SD) units and frequency-domain (FD) units according to embodiments of the present disclosure;

FIG. 10 illustrates an example two-sided model according to embodiments of the present disclosure;

FIG. 11 illustrates an example open RAN (O-RAN) system according to embodiments of the present disclosure;

FIG. 12 illustrates an example port group (PG) according to embodiments of the present disclosure;

FIG. 13 illustrates an example codebook according to embodiments of the present disclosure;

FIG. 14 illustrates an example artificial intelligence (AI)-native CSI configuration according to embodiments of the present disclosure;

FIG. 15 illustrates examples of convolution configurations according to embodiments of the present disclosure;

FIG. 16 illustrates an example entropy distribution according to embodiments of the present disclosure;

FIG. 17 illustrates an example convolution operation according to embodiments of the present disclosure;

FIG. 18 illustrates an example complex-values matrix/vector according to embodiments of the present disclosure;

FIG. 19 illustrates an example neural network (NN)-based auto-encoder (AE) according to embodiments of the present disclosure;

FIG. 20 illustrates an example linear AE according to embodiments of the present disclosure;

FIG. 21 illustrates an example multi-layer AE according to embodiments of the present disclosure;

FIG. 22 illustrates an example linear AE according to embodiments of the present disclosure;

FIG. 23 illustrates an example multi-layer linear AE according to embodiments of the present disclosure;

FIG. 24 illustrates linear AE according to embodiments of the present disclosure;

FIG. 25 illustrates linear AE according to embodiments of the present disclosure;

FIG. 26 illustrates an example multi-layer AE according to embodiments of the present disclosure;

FIG. 27 illustrates an example multi-layer AE according to embodiments of the present disclosure;

FIG. 28 illustrates an example non-linear AE (NL-AE) according to embodiments of the present disclosure;

FIG. 29 illustrates an example multi-layer NL-AE according to embodiments of the present disclosure;

FIG. 30 illustrates an example multi-layer NL-AE according to embodiments of the present disclosure;

FIG. 31 illustrates an example multi-layer NL-AE according to embodiments of the present disclosure;

FIG. 32 illustrates an example NL-AE according to embodiments of the present disclosure;

FIG. 33 illustrates an example NL-AE according to embodiments of the present disclosure;

FIG. 34 illustrates an example NL-AE according to embodiments of the present disclosure;

FIG. 35 illustrates an example NL-AE according to embodiments of the present disclosure;

FIG. 36 illustrates an example one-sided/linear AE according to embodiments of the present disclosure;

FIG. 37 illustrates an example linear auto-decoder (L-AD) according to embodiments of the present disclosure;

FIG. 38 illustrates an example non-linear auto-decoder (NL-AD) according to embodiments of the present disclosure;

FIG. 39 illustrates an example NL-AD according to embodiments of the present disclosure;

FIG. 40 illustrates an example NL-AD according to embodiments of the present disclosure;

FIG. 41 illustrates an example NL-AD according to embodiments of the present disclosure;

FIG. 42 illustrates a flowchart of an example procedure for UE-side training according to embodiments of the present disclosure;

FIG. 43 illustrates an example single layer CNN with multiple output channels according to embodiments of the present disclosure;

FIG. 44 illustrates an example single layer CNN according to embodiments of the present disclosure;

FIG. 45 illustrates an example single layer CNN with (non-linear) activation according to embodiments of the present disclosure; and

FIG. 46 illustrates an example method performed by a UE in a wireless communication system according to embodiments of the present disclosure.

### DETAILED DESCRIPTION

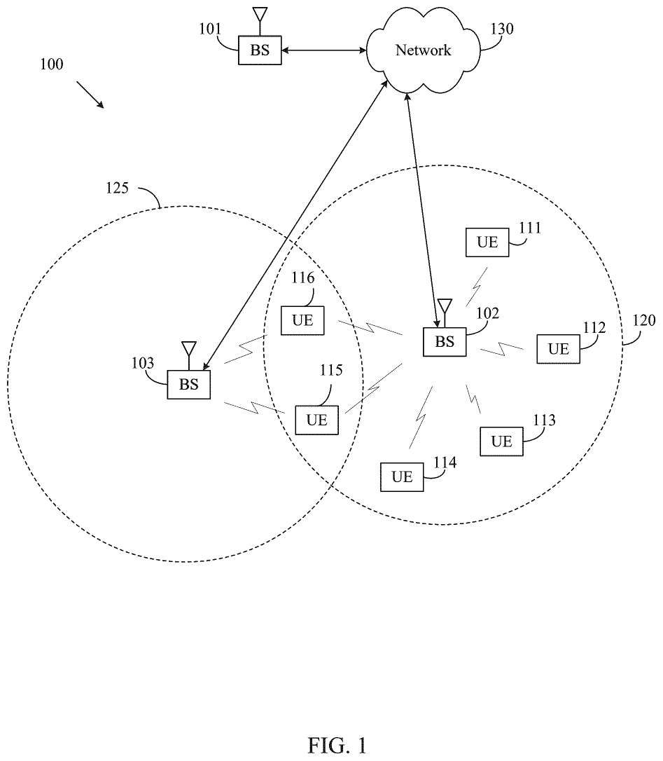

FIGS. 1-46 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP, TS 38.211, 5G; NR; Physical channels and modulation; [REF 2] 3GPP, TS 38.331, 5G; NR; Radio Resource Control (RRC); Protocol specification; [REF 3] 3GPP, TS 38.321, 5G; NR; Medium Access Control (MAC); Protocol specification; [REF 4] 3GPP, TS 38.214, 5G; NR; Physical layer procedures for data; [REF 5] https://mathworld.wolfram.com/ToeplitzMatrix.html; [REF 6] M. Wax and T. Kailath, “Efficient inversion of a doubly block Toeplitz matrix”, in Proc. IEEE ICASSP, pp. 170-173, Apr. 14-16, 1983; [REF 7] https://mathworld.wolfram.com/CirculantMatrix.html; [REF 8] A. Araujo, “Building Compact and Robust Deep Neural Networks with Toeplitz Matrices”, https://arxiv.org/pdf/2109.00959.pdf; [REF 9] 3GPP TS 38.212 v18.0.0, “E-UTRA, NR, Multiplexing and Channel coding;” [REF 10] 3GPP TS 38.213 v18.0.0, “E-UTRA, NR, Physical Layer Procedures for Control;” [REF 11] O-RAN.WG4.CONF.0-R003-v09.00, “O-RAN Working Group 4 (Fronthaul Working Group) Conformance Test Specification;” [REF 12] O-RAN.WG4.CUS.0-R003-v13.00, “O-RAN Working Group 4 (Open Fronthaul Interfaces WG)-Control, User and Synchronization Plane Specification; [REF 13] 3GPP TR 38.843, Study on Artificial Intelligence (AI)/Machine Learning (ML) for NR air interface; [REF 14] H. Ngo et al., “Cell-free massive MIMO versus small cells,” IEEE Transactions on Wireless Communications, vol. 16, no. 3, March 2017; [REF 15] H. Ngo et al., “On the total energy efficiency of cell-free massive MIMO,” IEEE Transactions on Green Communications and Networking, vol. 2, no. 1, pp. 25-39, March 2018; [REF 16] G. Interdonato et al., “Ubiquitous cell-free massive MIMO communications,” EURASIP J. Wireless Commun. Netw., vol. 2019, no. 197, August 2019; [REF 17] J. Jeon et al., “MIMO evolution towards 6G: Modular massive MIMO in low-frequency bands,” IEEE Communications Magazine, vol. 59, pp. 52-58, November 2021; [REF 18] E. Onggosanusi et al., “Modular and high-resolution channel state information and beam management for 5G new radio,” IEEE Communications Magazine, vol. 56, no. 3, pp. 48-55, March 2018; [REF 19] 3GPP RANI contribution RP-213517, MIMO evolution for downlink and uplink, Samsung; and [REF 20] P. Madadi et al., “PolarDenseNet: A Deep Learning Model for CSI Feedback in MIMO Systems”, https://arxiv.org/pdf/2202.01246.pdf.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for learning based CSI reporting. In certain embodiments, one or more of the BSs 101-103 include circuitry, programing, or a combination thereof to support learning based CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

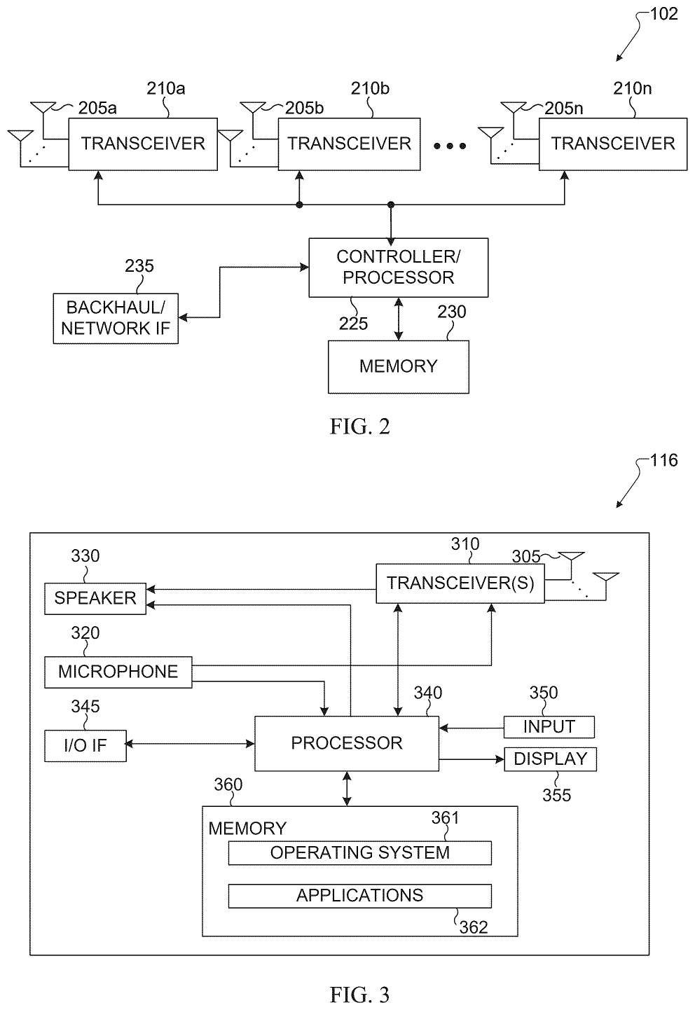

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for learning based CSI reporting. Any of a wide variety of other functions could be supported in the gNB 102 by the controller/processor 225.

The controller/processor 225 is also capable of executing programs and other processes resident in the memory 230, such as processes to support learning based CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for learning based CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

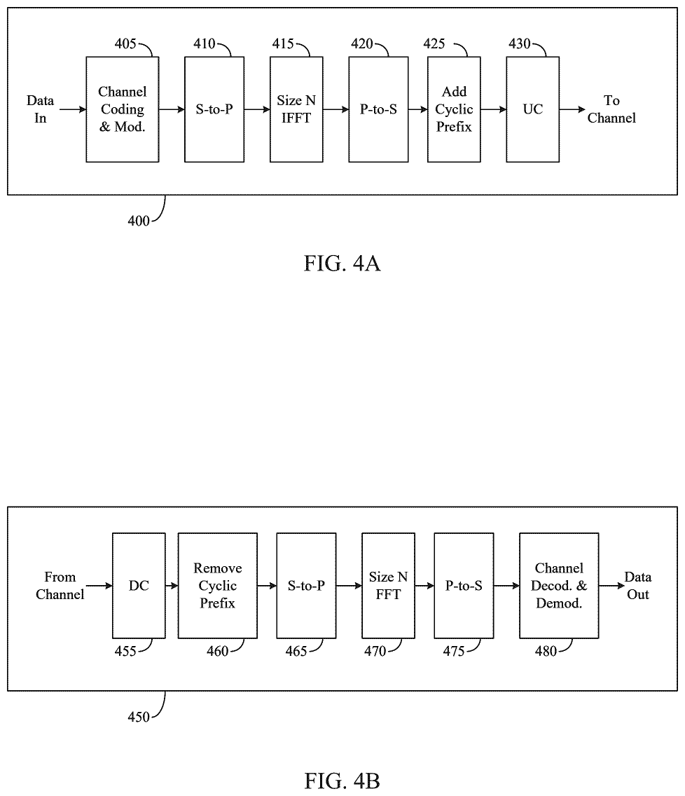

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for learning based CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

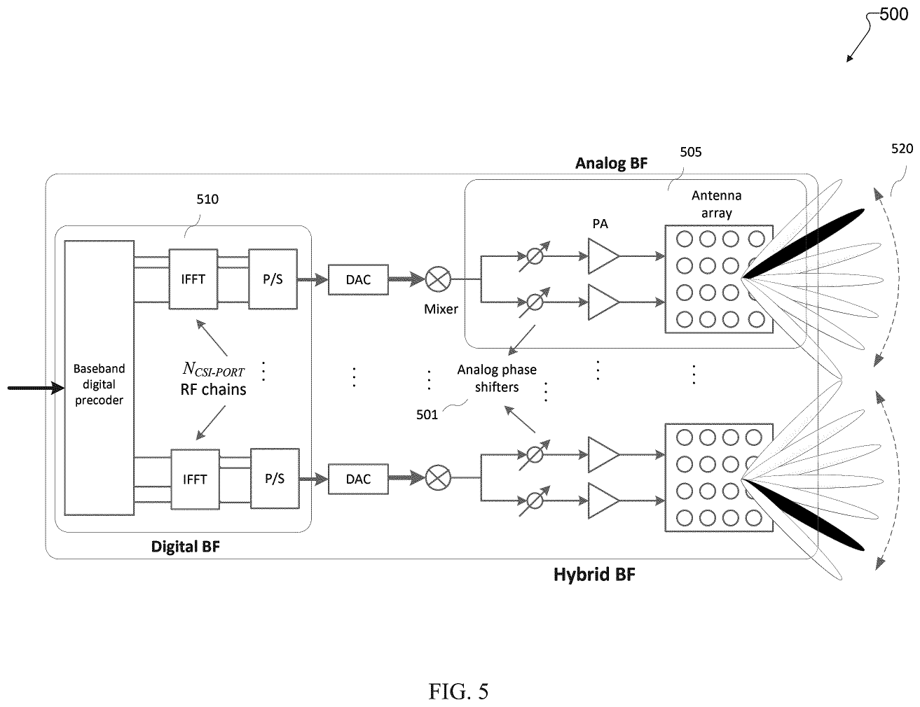

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication/information CSI reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NeSI-PORT. A digital beamforming unit 510 performs a linear combination across NOSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed evaluating carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiple user multiple-input-multiple-output (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

The present disclosure relates generally to wireless communication systems and, more specifically, to Deep-learning-based precoding in next generation of communication (e.g. 6G) systems.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range | Corresponding |
|---|---|
| designation | frequency range |
| FR1 | 450 MHz-6000 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g. 6G), in addition to FR1 and FR2, new carrier frequency bands can be taken into account, e.g., FR4 (>52.6 GHz), terahertz (>100 GHz) and upper mid-band (7-15 GHz), aka FR3. The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

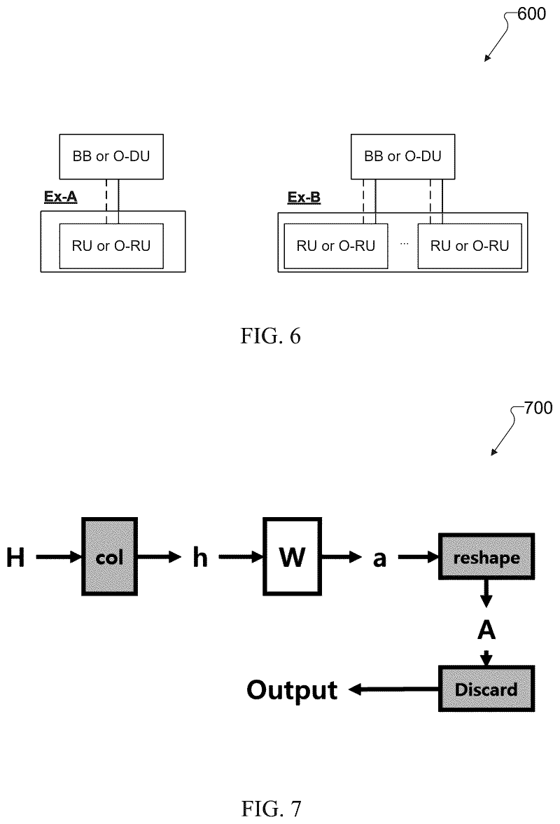

FIG. 6 illustrates a diagram of example RAN configurations 600 according to embodiments of the present disclosure. For example, RAN configurations 600 can be implemented by the BS 102 of FIG. 1. This example is for illustration only and other embodiments can be used without departing from the scope of the present disclosure.

Likewise, for O-RAN, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 6.

The following are defined in [REF7 and REF8].

| | |
|---|---|
| O-CU | O-RAN Central Unit - a logical node hosting PDCP, |
| | RRC, SDAP and other control functions |
| O-DU | O-RAN Distributed Unit: a logical node hosting |
| | RLC/MAC/High-PHY layers based on a lower layer |
| | functional split. O-DU in addition hosts |
| | an M-Plane instance. |
| O-RU | O-RAN Radio Unit: a logical node hosting Low-PHY |
| | layer and RF processing based on a lower layer |
| | functional split. This is similar to 3GPP's “TRP” |
| | or “RRH” but more specific in including the |
| | Low-PHY layer (FFT/iFFT, PRACH extraction). |
| | O-RU in addition hosts M-Plane instance. |

The 5th generation (5G) standard supports several features, but only a handful of them is implemented in real products. The main reason is owing to complexity, feasibility, and market need of those features. 6G should therefore be (a) aimed for realistic antenna structures, deployment scenarios, and feasibility of features, (b) simpler than 5G (to ease implementations), whenever feasible (c) learning-based (for adaptability and future-proofness). Just like 5G, multiple-input multiple-output (MIMO) is expected to encompass key enabling technologies/features to meet data-rate requirements in the 6th generation (6G) as well. In particular, a codebook-based channel state information (CSI) acquisition at the network (NW) is likely to remain crucial for frequency division duplexing (FDD) as well as time division duplexing (TDD) bands in real 6G NW deployments.

The codebook-based CSI in 5G is based on a fixed-basis. In spatial domain (SD), the fixed-basis is designed expecting a structured (e.g. planar dual-polarized) antenna port layout, taking into account one or multiple of such layouts located at transmit-receive points (TRPs). The fixed-basis is optimized depending on deployment of these TRPs (co-located vs distributed) and transmission hypotheses, i.e., TRP selection vs non-coherent joint transmission (NCJT) vs coherent JT (CJT). For further CSI compression, the fixed-basis is extended in frequency domain (FD) and Doppler domain (DD). As many as 20 codebooks (at least one codebook per 5G release) have been specified thus far, cf. Table 1. This approach of designing codebooks is becoming untenable. Especially in 6G, the fixed-basis is quite limited in its utility due to (i) more diverse and less-structured and non-planar antenna types, e.g. reconfigurable intelligent surface (RIS), three-dimensional (3D) cylindrical/semi-spherical antenna may be used, while two-dimensional (2D) planar array is still relevant, and (ii) NW deployment/topology is expected to be more distributed due to large antenna form factor (in low band), channel-sparsity, or rank-deficiency (in higher bands), implying larger number of antenna ports (e.g. up to 256) than 5G. Taking into account the herein, a unified future-proof design while still highly performing for key scenarios is deemed necessary. The design should be upgradable (based on parameterized components), scalable (as number of antenna ports grows or geometry or distribution evolves), and learning-based (if/when feasible). A new CSI paradigm, namely artificial intelligence (AI)-native CSI provided in this disclosure can be instrumental in this regard.

TABLE 1

| 5G Release | Fixed-basis codebooks |
|---|---|
| 15 | Type I (T1)-single panel, |
| | CodebookMode = 1, 2 |
| | T1-multi-panel, CodebookMode = 1, 2 |
| | Type II (T2) |
| | T2-port selection (PS) |
| 16 | Enhanced T2 (eT2) |
| | eT2-PS |
| 17 | Further eT2-PS (feT2-PS) |
| 18 | eT2-CJT, CodebookMode = 1, 2 |
| | eT2-Doppler |
| | feT2-PS-CJT, CodebookMode = 1, 2 |
| | feT2-PS-Doppler |
| 19 | Enhanced T1, CodebookMode = 1, 2 |
| | eT2 for >32 ports |
| | eT2-Doppler >32 ports |
| | feT2-PS >32 ports |

Up to a 5G network (NW) can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHZ (FR2), i.e., for mm Wave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mm Wave frequencies, each antenna panel requires dynamic frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of physical resource blocks (PRBs), and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-) MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Expecting that the NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

In 5G NR, a significant improvement in throughput can be obtained by supporting MU-MIMO transmission, where one gNB (e.g., the BS 102) simultaneously transmits multiple data streams to multiple UEs. MU-MIMO transmission relies on the availability of accurate DL CSI at the gNB; in FDD systems, each UE measures DL CSI and reports its measurements. Each CSI report can include precoding matrix indicator (PMI) (the dominant channel directions), rank indicator (RI) (the number of dominant channel directions), and/or channel quality indicator (CQI) (the best modulation and code rate that the channel can support).

The overhead of DL CSI increases with the number of antenna ports at the gNB and the number of SBs. Current 5G systems support tens of SBs and a maximum of 32 antenna ports at the gNB. Each UE uses pre-defined codebooks (e.g. Type I and Type II) for compressing DL CSI before it is reported to the gNB. These codebooks exploit channel correlations in the spatial and frequency domains; the application of these codebooks has significantly reduced the overhead of DL CSI feedback. In Release-18, these codebooks are extended to exploit channel correlations in the temporal domain; the application of these codebooks could yield additional reductions in the overhead of DL CSI feedback.

The number of antenna ports at the gNB and the number of SBs are expected to increase for future systems to meet more stringent performance requirements-yet the overhead reduction from pre-defined codebooks may not scale accordingly (e.g. Type I and Type II codebooks utilize a DFT basis, which may not be applicable to future antenna configurations).

Besides, 5G NR codebooks (CBs) compress the CSI in the spatial/angle (introduced in Rel-15), frequency/delay (introduced in Rel-16), and time/Doppler (introduced in Rel-18) domains. The 5G NR CBs employ DFT basis vectors-based compression exploiting the sparsity of the channel (fewer significant coefficients) in certain domain (angle/delay/Doppler), DFT basis vectors-based representation of precoding vectors is computationally advantageous, e.g., O (n²) complexity for basis matrix inversion. However, basis vectors-based representation may incur a non-trivial approximation error due to incomplete basis representation, fixed basis sampling, fixed (RRC-configured) number of basis vectors, etc. An example in which the channel strength in the spatial-frequency domain and angel-delay domain for a single layer precoding vectors (32 ports and 13 subbands) is taken into account. Rel-16 eType II codebook exploits the sparsity of the strong angle-delay coefficients for feedback overhead reduction, i.e., e.g., reports coefficients, say, corresponding to L=4 angle (beam) per polarization and M=3 delay components (basis vectors). The components, which are still significant but not reported by the eType II-based CSI feedback, contribute to the performance (accuracy) gap from the ideal feedback.

Taking into account the issues mentioned herein with 5G NR (DFT-based fixed) CBs, it may be advantageous to configure a UE to support alternate methods of compressing DL CSI. For instance, deep-learning or AI/ML-based CSI feedback has a potential of providing better accuracy-overhead trade-off via non-linear compression. The following are the potential benefits of AI/ML-based CSI feedback.
Better performance, i.e., CSI feedback accuracy-overhead trade-off
Antenna panels/arrangements agnostic as opposed to the limitation of NR CBs to ULA
Better flexibility to support variable CSI feedback payload size
Capability to scale with a larger CSI dimensions (large number of ports, SD/FD/TD granularities, etc.)

FIG. 7 illustrates an example CNN 700 according to embodiments of the present disclosure. For example, CNN 700 can be implemented by any of the UEs 111-116 of FIG. 1. This example is for illustration only and other embodiments can be used without departing from the scope of the present disclosure.

For example, expect that an AI/ML model architecture can be designed to train an autoencoder for generating/reporting CSI feedback, where the encoder utilizes a single CNN layer. When this trained autoencoder is used for inference, applying this CNN layer is equivalent to pre-multiplying its input by a Toeplitz (or doubly-block Toeplitz, circulant, doubly-block circulant, concatenation of doubly-block Toeplitz/circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix. In addition, 3-D linear convolution is equivalent to pre-multiplication by a matrix that includes a concatenation of doubly-block Toeplitz matrices [8].

An example is shown in FIG. 7 for the a single layer CNN, where the Kernel is a vector/matrix (e.g. a vector if learning/training is only SD, and a matrix if it is on both SD and FD). The Convolution is equivalent to the following:
Create column vector from input H, i.e. h
a=W*h (where W is a Kernel matrix/vector based on doubly-block Toeplitz)
   Zero-pad kernel to create W
Reshape a to matrix A
   For each row in A, discard entries from partial kernel overlap with H

The W is essentially a Toeplitz matrix when the Kernel is a vector, and a doubly Toeplitz matrix when the Kernel is a matrix. A Toeplitz matrix [5] has constant (same) values along its negative-sloping diagonals; an example is shown in (1) as values . . . , a₋₁, a₀, a₁, . . . .

$$A = ( \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ) \qquad ( 1 )$$

A doubly-block Toeplitz matrix [6] is a block matrix R where 1) its (i,j)-th block Rᵢⱼ is a function of i-j (thus, it can be denoted by Rᵢ₋ⱼ) and 2) Rᵢⱼ (denoted by Rᵢ₋ⱼ) is itself a Toeplitz matrix. An example is shown in (2), where each Rⱼ is a Toeplitz matrix.

$$R = ( \begin{matrix}{R}_{0} & {R}_{- 1} & {R}_{- 2} & ⋯ & {R}_{- n + 1} \\ {R}_{1} & {R}_{0} & {R}_{- 1} & ⋱ & ⋮ \\ {R}_{2} & {R}_{1} & {R}_{0} & ⋱ & {R}_{- 2} \\ ⋮ & ⋱ & ⋱ & ⋱ & {R}_{- 1} \\ {R}_{n - 1} & ⋯ & {R}_{2} & {R}_{1} & {R}_{0}\end{matrix} ) \qquad ( 2 )$$

A circulant matrix [7] is a special case of a Toeplitz matrix where each row (column) is a circular shift of the previous row (column). An example is shown in (3).

$$A = ( \begin{matrix}{a}_{0} & {a}_{- 1} & {a}_{- 2} & ⋯ & {a}_{- n + 1} \\ {a}_{- n + 1} & {a}_{0} & {a}_{- 1} & ⋱ & {a}_{- n + 2} \\ {a}_{- n + 2} & {a}_{- n + 1} & {a}_{0} & ⋱ & {a}_{- n + 3} \\ ⋮ & ⋱ & ⋱ & ⋱ & ⋮ \\ {a}_{- 1} & ⋯ & {a}_{- n + 2} & {a}_{- n + 1} & {a}_{0}\end{matrix} ) \qquad ( 3 )$$

A doubly-block circulant matrix is a special case of a doubly-block Toeplitz matrix R where 1) each block row (column) is a circular shift of the previous block row (column) and 2) its (i,j)-th block Rᵢⱼ (denoted by Rᵢ₋ⱼ) is itself a circulant matrix. An example is shown in (4), where each Rⱼ is a circulant matrix.

$$R = ( \begin{matrix}{R}_{0} & {R}_{- 1} & {R}_{- 2} & ⋯ & {R}_{- n + 1} \\ {R}_{- n + 1} & {R}_{0} & {R}_{- 1} & ⋱ & {R}_{- n + 2} \\ {R}_{- n + 2} & {R}_{- n + 1} & {R}_{0} & ⋱ & {R}_{- n + 3} \\ ⋮ & ⋱ & ⋱ & ⋱ & ⋮ \\ {R}_{- 1} & ⋯ & {R}_{- n + 2} & {R}_{- n + 1} & {R}_{0}\end{matrix} ) \qquad ( 4 )$$

Thus, using this trained autoencoder for inference is equivalent to applying a Toeplitz-based method for generating/reporting CSI feedback. This Toeplitz-based method can utilize a flexible basis that depends on a training dataset.

The 5G CSI is based on a fixed-basis codebook. Embodiments of the present disclosure recognize that the fixed-basis approach is unscalable and non-future-proof, since it requires specific designs tailored for CSI compression/resolution type, deployment scenario, transmission hypothesis, and operating carrier frequency, as is evident from close to two dozen codebooks specified in 5G. AI-native is expected to be an integral part of a 6G system, hence can be instrumental in designing a scenario-driven learning-based basis, whenever feasible, as a replacement for the fixed-basis. One such AI-native CSI is provided in this disclosure. In particular, a CNN-based deep-learning-basis is provided to compress CSI. The system-level performance benefits of the implementation are demonstrated for two scenarios, single TRP and multiple TRP CJT.

The present disclosure describes a framework for learning-based (aka AI-native) CSI. Details on the support of CNN-based methods for generating/reporting CSI are disclosed, including information elements to be exchanged between a transmitter and a receiver. The following aspects are provided in the disclosure:
Two-sided model with convolutional auto-encoder
Signaling details

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

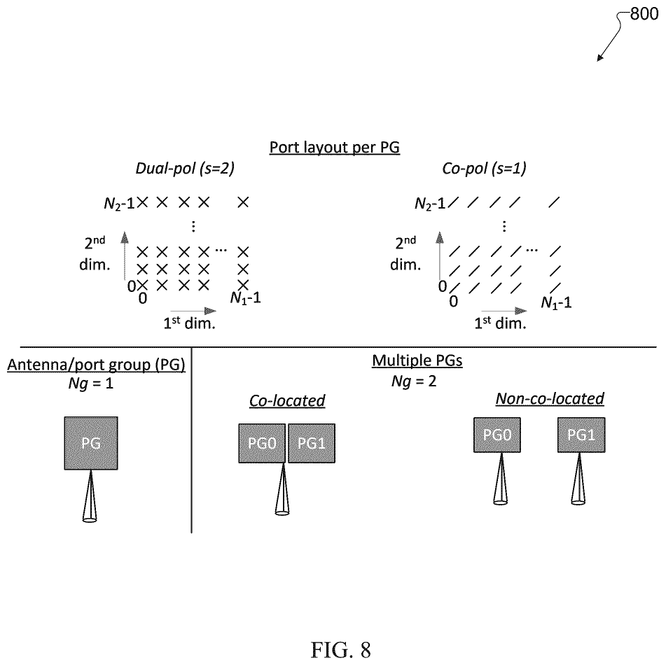

FIG. 8 illustrates an example antenna port layout 800 according to embodiments of the present disclosure. For example, antenna port layout 800 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either have N₁>1 and N₂=1 or N₂>1 and N₁=1. In the rest of the disclosure, 1D antenna port layouts with N₁>1 and N₂=1 is taken into account. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 8 where “X” represents two antenna polarizations (dual-pol, s=2) and “/” represents one antenna polarization (co-pol, s=1). In this disclosure, the term “polarization” refers to a group of antenna ports with the same polarization. For example, antenna ports j=X+0, X+1, . . . ,

$$X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 ,$$

. . . X+P_{CSIRS}−1 comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=SN₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 8. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-) configured more dynamically (e.g. via MAC CE or/and downlink control information (DCI)). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 8. The antenna structure at each PG or O-RU (or RU) can be the same. Or, the antenna structure at an PG or O-RU (or RU) can be different from another PG or O-RU (or RU). Likewise, the number of ports at each PG (OR O-RU OR RU) can be the same. Or, the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is provided in the rest of the disclosure. For simplicity, each PG (OR O-RU OR RU) is equivalent to a panel (cf. FIG. 8), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one embodiment, an PG (OR O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CQI report interval (CRI) or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

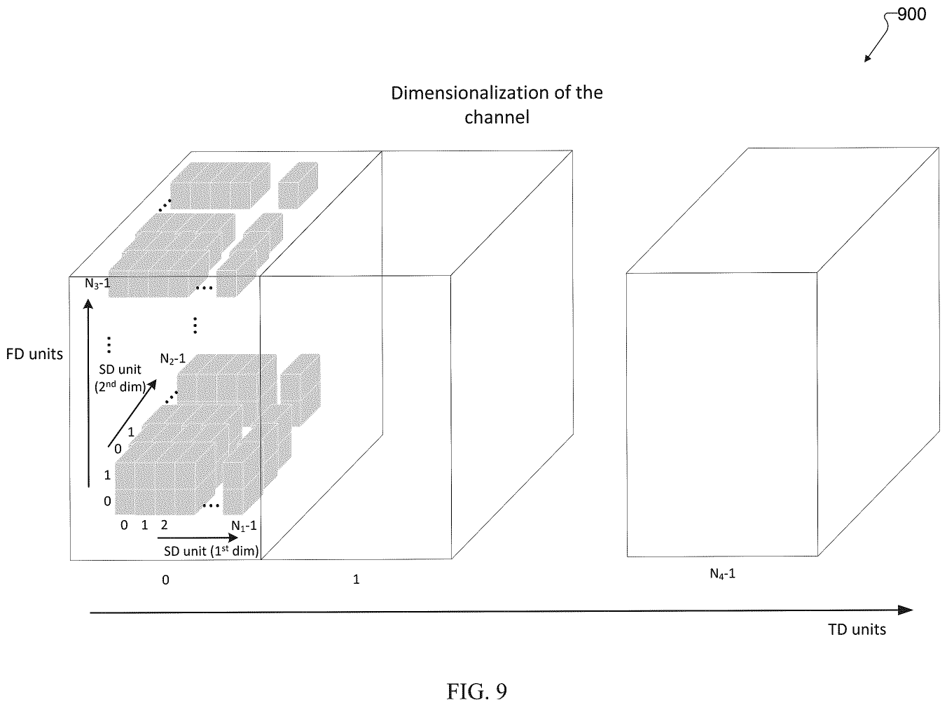

FIG. 9 illustrates a timeline 900 of example SD units and FD units according to embodiments of the present disclosure. For example, timeline 900 can be followed by any of the UEs 111-116 of FIG. 1, such as the UE 116. This example is for illustration only and other embodiments can be used without departing from the scope of the present disclosure.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1st and 2nd antenna dimensions), FD units, and, and TD units is shown in FIG. 9.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG or O-RU (or RU) comprising P_{CSIRS} ports, and the CSI report is based on the channel measurement from the one PG or O-RU (or RU).
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG or O-RU (or RU) (one-to-one mapping). In one example, multiple CMRs can correspond to an PG or O-RU (or RU) (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or, it can be indicated via a MAC CE. Or, it can be provided via a DCI field.

Likewise, the value of K can be configured, e.g. via higher layer RRC parameter. Or, it can be indicated via a MAC CE. Or, it can be provided via a DCI field.

In one example, K=N_{g}=X. The value of X can be configured, e.g. via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

For illustrative purposes, a term “Toeplitz-based CSI feedback/report” is used to refer to a method for generating CSI reports that is based on a first component (or basis) W₁ which has a convolutional structure. For instance, the convolutional structure can correspond to a Toeplitz (or doubly-block Toeplitz, circulant, doubly-block circulant, concatenation of doubly-block Toeplitz/circulant) matrix. The CSI reports are based on a dual-stage precoding structure, where the first stage can correspond to the convolutional W₁ and the second stage can correspond to a second component (or coefficients) W₂. The overall precoding operation essentially can be expressed as W₁W₂, i.e., multiplication of a coefficient matrix (W₂) by a Toeplitz (or doubly-block Toeplitz, circulant, doubly-block circulant, concatenation of doubly-block Toeplitz/circulant) matrix (W₁). In this case, this Toeplitz (or doubly-block Toeplitz, circulant, doubly-block circulant, concatenation of doubly-block Toeplitz/circulant) matrix is analogous to the basis matrices W₁ and/or W_{f} and/or W_{d} or three sets of basis vectors (L vectors, Mᵥ or M vectors, and D vectors) as in the Type II codebooks (cf. 5.2.2.2.3/4/5/6/7/8/9/10/11, [4]) that perform compression in SD and/or FD and/or DD/TD, respectively.

If the convolutional structure of W₁ corresponds to a Toeplitz (or doubly-block Toeplitz, circulant, doubly-block circulant, concatenation of doubly-block Toeplitz/circulant) matrix, this Toeplitz (or doubly-block Toeplitz, circulant, doubly-block circulant, concatenation of doubly-block Toeplitz/circulant) matrix can be a square (e.g. n×n) matrix. This Toeplitz (or doubly-block Toeplitz, circulant, doubly-block circulant, concatenation of doubly-block Toeplitz/circulant) matrix can also be a tall (e.g. m×n, where m>n) or fat (e.g. n×m, where m>n) matrix.

Other terms that refer to a same method can also be used.

In one embodiment, for the space and temporal domains, the precoding matrix based on this disclosure has the following structure:

$$P = \frac{1}{γ} {W}_{1} {W}_{2} {W}_{d}^{H} = \frac{1}{γ} {ACA}_{d}^{H} = {\frac{1}{γ} [ \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ] [ \begin{matrix}{c}_{0 , 0} & {c}_{0 , 1} & & {c}_{0 , m - 1} \\ ⋮ & ⋮ & ⋯ & ⋮ \\ {c}_{n - 1 , 0} & {c}_{n - 1 , 1} & & {c}_{n - 1 , m - 1}\end{matrix} ] [ \begin{matrix}{a}_{d , 0} & {a}_{d , - 1} & {a}_{d , - 2} & ⋯ & {a}_{d , - m + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , m - 1} & ⋯ & {a}_{d , 2} & {a}_{f , 1} & {a}_{d , 0}\end{matrix} ]}^{H} \qquad ( 7 )$$

where γ is a normalization factor. In one example, W₁ is an SD basis (e.g. across P_{CSIRS} CSI-RS antenna ports), and W_{d} is a DD/TD basis. The quantities a₋ₙ₊₁ . . . , a₋₁, a₀, a₁, . . . , aₙ₋₁ and/or a_{d,-m+1} . . . , a_{d,-1}, a_{d,0}, a_{d,1}, . . . , a_{d,m-1} in (7) can be configured to be determined by training an AI/ML model architecture. In another example, the quantities a₋ₙ₊₁ . . . , a₋₁, a₀, a₁, . . . , aₙ₋₁ and/or a_{d,-m+1} . . . , a_{d,-1}, a_{d,0}, a_{d,1}, . . . , a_{d,m-1} in (7) can be configured from a candidate set of quantities. In another example, the quantities a₋ₙ₊₁ . . . , a₋₁, a₀, a₁, . . . , aₙ₋₁ and/or a_{d,-m+1} . . . , a_{d,-1}, a_{d,0}, a_{d,1} . . . , a_{d,m-1} in (7) can be specified.

In a variation, the precoding matrix based on this disclosure has the following structure:

$$P = \frac{1}{γ} {W}_{1} {W}_{2} {W}_{d}^{H} = \frac{1}{γ} [ \begin{matrix}{A}_{1} & 0 \\ 0 & {A}_{2}\end{matrix} ] {CA}_{d}^{H} \qquad ( 8 )$$

where γ is a normalization factor. In one example, W₁ is an SD basis for two antenna groups (e.g. two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$P = \frac{1}{γ} {W}_{1} {W}_{2} = \frac{1}{γ} {A}_{s , d} C = \frac{1}{γ} [ \begin{matrix}{a}_{s , d , 0} & {a}_{s , d , - 1} & {a}_{s , d , - 2} & … & {a}_{s , d , - n + 1} \\ {a}_{s , d , 1} & {a}_{s , d , 0} & {a}_{s , d , - 1} & ⋱ & ⋮ \\ {a}_{s , d , 2} & {a}_{s , d , 1} & {a}_{s , d , 0} & ⋱ & {a}_{s , d , - 2} \\ ⋮ & ⋱ & ⋱ & ⋱ & {a}_{s , d , - 1} \\ {a}_{s , d , n - 1} & … & {a}_{s , d , 2} & {a}_{s , d , 1} & {a}_{s , d , 0}\end{matrix} ] [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] \qquad ( 8 - sd )$$

where γ is a normalization factor. In one example, W₁ is a joint SD-DD/TD basis. The quantities a_{s,d,-n+1} . . . , a_{s,d,-1}, a_{s,d,0}, a_{s,d,1}, . . . , a_{s,d,n-1} in (8-sd) can be configured to be determined by training an AI/ML model architecture. In another example, the quantities a_{s,d,-n+1} . . . , a_{s,d,-1}, a_{s,d,0}, a_{s,d,1}, . . . , a_{s,d,n-1} in (8-sd) can be configured from a candidate set of quantities. In another example, the quantities a_{s,d,-n+1} . . . , a_{s,d,-1}, a_{s,d,0}, a_{s,d,1}, . . . , a_{s,d,n-1} in (8-sd) can be specified.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {AC ( {A}_{f} ⊗ {A}_{d} )}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] * [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H} \qquad ( 13 )$$

where γ is a normalization factor. In one example, W₁ is an SD basis (e.g. across P_{CSIRS} CSI-RS antenna ports), W_{f} is an FD basis, and W_{d} is a DD/TD basis. The quantities a₋ₙ₊₁ . . . , a₋₁, a₀₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (13) can be configured to be determined by training an AI/ML model architecture. In another example, the quantities a₋ₙ₊₁ . . . , a₋₁, a₀, a₁, . . . , aₙ₋₁, a_{f,-m+1} . . . , a_{f,-1}, a_{f,0}, a_{f,1}, . . . , a_{f, m-1}, and/or a_{d,-p+1} . . . , a_{d,-1}, a_{d,0}, a_{d,1}, . . . , a_{d,p-1} in (13) can be configured from a candidate set of quantities. In another example, the quantities a₋ₙ₊₁ . . . , a₋₁, a₀, a₁, . . . , aₙ₋₁, a_{f,-m+1} . . . , a_{f,-1}, a_{f,0}, a_{f,1} . . . , a_{f, m-1}, and/or a_{d,-p+1} . . . , a_{d,-1}, a_{d,0}, a_{d,1}, . . . , a_{d,p-1} in (13) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] {C ( {A}_{f} ⊗ {A}_{d} )}^{H} \qquad ( 14 )$$

where γ is a normalization factor. In one example, W₁ is an SD basis for two antenna groups (e.g. two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$P = \frac{1}{γ} {W}_{1} {W}_{2} {W}_{f , d}^{H} = \frac{1}{γ} {ACA}_{f , d}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {[ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]}^{H} \qquad ( 13 - fd )$$

where γ is a normalization factor. In one example, W₁ is an SD basis (e.g. across P_{CSIRS} CSI-RS antenna ports) and W_{f,d} is a joint FD-DD/TD basis. The quantities a₋ₙ₊₁ . . . , a₋₁, a₀, a₁, . . . , aₙ₋₁ and/or a_{f, d,-m+1} . . . , a_{f,d,-1}, a_{f,d,0}, a_{f,d,1}, . . . , a_{f, d,m-1} in (13-fd) can be configured to be determined by training an AI/ML model architecture. In another example, the quantities a₋ₙ₊₁ . . . , a₋₁, a₀, a₁, . . . , aₙ₋₁ and/or a_{f,d,-m+1} . . . , a_{f,d,-1}, a_{f,d,0}, a_{f,d,1}, . . . , a_{f,d,m-1} in (13-fd) can be configured from a candidate set of quantities. In another example, the quantities a₋ₙ₊₁ . . . , a₋₁, a₀, a₁, . . . , aₙ₋₁ and/or a_{f,d,-m+1} . . . , a_{f,d,-1}, a_{f,d,0}, a_{f,d,1}, . . . , a_{f, d,m-1} in (13-fd) can be specified.

In a variation, the precoding matrix based on this disclosure has the following structure:

$$P = \frac{1}{γ} {W}_{1} {W}_{2} {W}_{f}^{H} = \frac{1}{γ} {A}_{s , d} {CA}_{f}^{H} = \frac{1}{γ} [ \begin{matrix}{a}_{s , d , 0} & {a}_{s , d , - 1} & {a}_{s , d , - 2} & … & {a}_{s , d , - n + 1} \\ {a}_{s , d , 1} & {a}_{s , d , 0} & {a}_{s , d , - 1} & ⋱ & ⋮ \\ {a}_{s , d , 2} & {a}_{s , d , 1} & {a}_{s , d , 0} & ⋱ & {a}_{s , d , - 2} \\ ⋮ & ⋱ & ⋱ & ⋱ & {a}_{s , d , - 1} \\ {a}_{s , d , n - 1} & … & {a}_{s , d , 2} & {a}_{s , d , 1} & {a}_{s , d , 0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} \qquad ( 13 - sd )$$

where γ is a normalization factor. In one example, W₁ is a joint SD-DD/TD basis and W_{f} is an FD basis. The quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (13-sd) can be configured to be determined by training an AI/ML model architecture. In another example, the quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f, m-1} in (13-sd) can be configured from a candidate set of quantities. In another example, the quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1} . . . , a_{f, m-1} in (13-sd) can be specified.

In a variation, the precoding matrix based on this disclosure has the following structure:

$$P = \frac{1}{γ} {W}_{1} {W}_{2} = \frac{1}{γ} {A}_{s , f , d} C = \frac{1}{γ} [ \begin{matrix}{a}_{s , f , d , 0} & {a}_{s , f , d , - 1} & {a}_{s , f , d , - 2} & … & {a}_{s , f , d , - n + 1} \\ {a}_{s , f , d , 1} & {a}_{s , f , d , 0} & {a}_{s , f , d , - 1} & ⋱ & ⋮ \\ {a}_{s , f , d , 2} & {a}_{s , f , d , 1} & {a}_{s , f , d , 0} & ⋱ & {a}_{s , f , d , - 2} \\ ⋮ & ⋱ & ⋱ & ⋱ & {a}_{s , f , d , - 1} \\ {a}_{s , f , d , n - 1} & … & {a}_{s , f , d , 2} & {a}_{s , f , d , 1} & {a}_{s , f , d , 0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] \qquad ( 13 - sfd )$$

where γ is a normalization factor. In one example, W₁ is a joint SD-FD-DD/TD basis. The quantities a_{s,f,d,-n+1} . . . , a_{s,f,d-1}, a_{s,f,d,0}, a_{s,f,d,1}, . . . , a_{s,f,d,n-1} in (13-sfd) can be configured to be determined by training an AI/ML model architecture. In another example, the quantities a_{s,f,d,-n+1} . . . , a_{s,f,d-1}, a_{s,f,d,0}, a_{s,f,d,1}, . . . , a_{s,f,d,n-1} in (13-sfd) can be configured from a candidate set of quantities. In another example, the quantities a_{s,f,d,-n+1} . . . , a_{s,f,d-1}, a_{s,f, d,0}, a_{s,f, d,1}, . . . , a_{s,f,d,n-1} in (13-sfd) can be specified.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {W}_{1} {C ( {A}_{f} ⊗ {A}_{d} )}^{H} = \frac{1}{γ} {W}_{1} * [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H} \qquad ( 27 )$$

where γ is a normalization factor and W₁ corresponds to a different basis from W_{f} and W_{d} (e.g. the DFT basis that is used to perform SD compression in the Rel. 16 eType II codebook). In one example, W_{f} is an FD basis, and W_{d} is a DD/TD basis. The quantities a_{f,-m+1} . . . , a_{f,-1}, a_{f,0}, a_{f,1} . . . , a_{f,m-1} and/or a_{d,-p+1} . . . , a_{d,-1}, a_{d,0}, a_{d,1}, . . . , a_{d,p-1} in (27) can be configured to be determined by training an AI/ML model architecture. In another example, the quantities a_{f,-m+1} . . . , a_{f,-1}, a_{f,0}, a_{f,1}, . . . , a_{f, m-1} and/or a_{d,-p+1} . . . , a_{d,-1}, a_{d,0}, a_{d,1}, . . . , a_{d,p-1} in (27) can be configured from a candidate set of quantities. In another example, the quantities a_{f,-m+1} . . . , a_{f,-1}>a_{f,0}, a_{f,1}, . . . , a_{f, m-1} and/or a_{d,-p+1} . . . , a_{d,-1}, a_{d,0}, a_{d,1}, . . . , a_{d,p-1} in (27) can be specified.

In a variation, the precoding matrix based on this disclosure has the following structure:

$$P = \frac{1}{γ} {W}_{1} {W}_{2} {W}_{f , d}^{H} = \frac{1}{γ} {W}_{1} {CA}_{f , d}^{H} = \frac{1}{γ} {W}_{1} * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {[ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]}^{H} \qquad ( 27 - fd )$$

where γ is a normalization factor and W₁ corresponds to a different basis from W_{f,d} (e.g. the DFT basis that is used to perform SD compression in the Rel. 16 eType II codebook). In one example, W_{f,d} is a joint FD-DD/TD basis. The quantities a_{f, d,-m+1} . . . , a_{f,d,-1}, a_{f,d,0}, a_{f,d,1}, . . . , a_{f, d,m-1} in (27-fd) can be configured to be determined by training an AI/ML model architecture. In another example, the quantities a_{f,d,-m+1} . . . , a_{f,d,-1}, a_{f,d,0}, a_{f,d,1}, . . . , a_{f,d,m-1} in (27-fd) can be configured from a candidate set of quantities. In another example, the quantities a_{f,d,-m+1} . . . , a_{f,d,-1}, a_{f, d,0}, a_{f,d,1}, . . . , a_{f, d,m-1} in (27-fd) can be specified.

In one example, the training of a codebook components (e.g. basis W1) is according to one of the three types in Table 2.

TABLE 2

| Type | Explanation |
|---|---|
| Type 1: joint ENC-DEC | No need for data sharing between |
| training | gNB and UE (data shared with an |
| | OTT or 3^{rd} party server) |
| Type 2: simultaneous, but | Data sharing |
| separate ENC-DEC training | |
| Type 3: sequential, but | One-side needs to share (albeit |
| separate ENC-DEC training | small amount of) data to the |
| | other side, e.g. NW/gNB to UE |

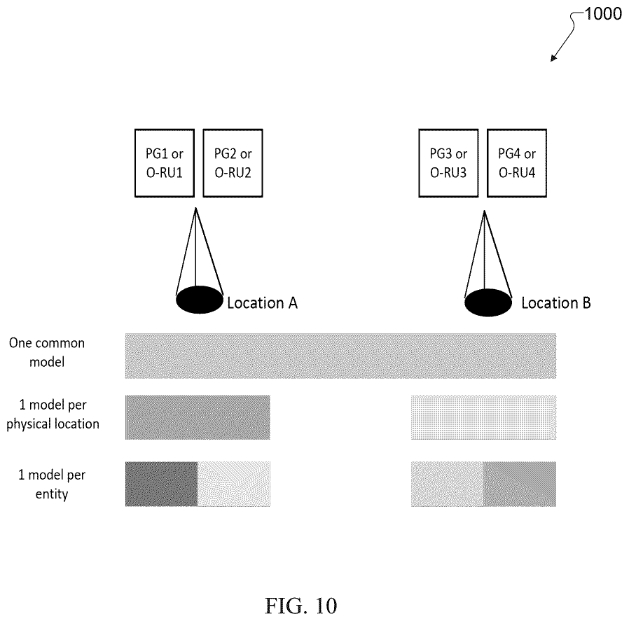

FIG. 10 illustrates an example two-sided model 1000 according to embodiments of the present disclosure. For example, two-sided model 1000 can be implemented by the UE 116 and the network 130 and/or gNB 102 in the wireless network 100 of FIG. 1. This example is for illustration only and other embodiments can be used without departing from the scope of the present disclosure.

In one embodiment, for a UE (e.g., the UE 116) connected to N_{g}≥1 NW entities (an entity e.g. can be TRP, antenna panel, beam, port, TXRU, DU, RU, O-RAN O-RU, cell (serving, non-serving)), a model for a AI/ML- or deep-learning-based CSI report is fixed or configured or indicated (via DCI or MAC CE) according to one of the following examples.

In one example, the number of models and their mapping to the entities are according to at least one of the following examples.
In one example, the model is fixed and common across entities (co-located (at one physical location) or non-co-located).
In one example, the model is fixed and common across entities that are co-located (at one physical location), and for non-co-located, from one site (physical location A) to another site (physical location B), the model can change (i.e. each site has its own model).
In one example, each entity has its own model regardless whether entities are co-located (at one physical location) or non-co-located.

These examples are illustrated in FIG. 10.

In one example, the model is for a first number of ports p₁, and the model for a second (larger than p₁) number of ports p₂=k×p₁ where k∈{1,2, 3, 4, . . . } is based on the model for the p₁ ports. For instance, using the model for p₁ ports k times can be one approach to apply the trained model for p₂ ports.

For example, when p₁=32 and p₂=64, there are options as follows. In Opt1, the model training is based on 32-port data.
Opt1-1: reducing 64 to 32 for training based on
   Opt1-1-1: one half, but including both polarizations
      Ports (0-15, 32-47)
   Opt1-1-2: both halves (2× data)
      Ports 0-31 and Ports 32-63
      (Ports 0-15 and 32-47) and (Ports 16-31 and 48-63)
Opt1-2: No training for 64 ports; use model M32 for each of the halves (as in Opt1-1-2)

In Opt2, the model training is based on 64-port data.
Opt2-1:2 models, each for 32 ports
   Reuse (existing) AI model training (for 32 ports)
Opt2-2:1 model

In one embodiment, the model for a 1D basis (e.g. W₁ in SD) is parameterized w.r.t. a 1D basis-related information. In one example, the information can be the size of the Kernel vector (L×1) where L is a length of the Kernel vector. In one example, the UE is configured with a Kernel or its parameter (e.g. via higher layer RRC, or via dynamic MAC CE or/and DCI indication). For multiple layers (v>1).

In one example, the value of L can be rank-common, i.e. the common/same model for each rank values.
In one example, the value of L can be rank-specific, i.e. one value of L for each rank value

TABLE 3

| ParamCombination | Kernel size |
|---|---|
| 0 | (L₀, M₀) |
| 1 | (L₁, M₁) |
| 2 | (L₂, M₂) |
| . . . | . . . |

TABLE 4

Kernel size

| | | | |
|---|---|---|---|
| ParamCombination | υ = 1 | υ = 2 | . . . |

| | | | |
|---|---|---|---|
| 0 | L₀ | M_{0, 0} | M_{0, 1} |
| 1 | L₁ | M_{1, 0} | M_{1, 1} |
| 2 | L₂ | M_{2, 0} | M_{2, 1} |
| . . . | | . . . | |

TABLE 5

Kernel size

| | | | |
|---|---|---|---|
| ParamCombination | υ ∈ {1, 2} | υ ∈ {3, 4} | . . . |

| | | | |
|---|---|---|---|
| 0 | L₀ | M_{0, 0} | M_{0, 1} |
| 1 | L₁ | M_{1, 0} | M_{1, 1} |
| 2 | L₂ | M_{2, 0} | M_{2, 1} |
| . . . | | . . . | |

In one embodiment, the model for a 2D basis (e.g. W1 in SD and Wf in FD) is parameterized w.r.t. a 2D basis-related information. In one example, the information can be the size of the Kernel vector (L×M) where L is a number of rows and M is a number of columns of the Kernel. In one example, the UE is configured with a Kernel or its parameters (e.g. via higher layer RRC, or via dynamic MAC CE or/and DCI indication). For multiple layers (v>1),
In one example, same values for rank values. An example is shown in Table 3.
In one example, both L and M are specific for a rank value.
In one example, L is specific for a rank value, and M is rank-common.
In one example, M is specific for a rank value, and L is rank-common. An example is shown in Table 4.
In one example, M is specific for a rank pair, and L is rank-common. An example is shown in Table 5.

In one embodiment, the model for basis (e.g. W₁) is parameterized w.r.t. basis-related information. In one example, the information can be the size of the Kernel matrix (L×M×D) where L is a number of units associated with a first dimension (e.g. SD), M is a number of units associated with a second dimension (e.g. FD), and D is a number of units associated with a third dimension (e.g. DD/TD). In one example, the UE is configured with a Kernel or its parameters (e.g. via higher layer RRC, or via dynamic MAC CE or/and DCI indication). For multiple layers (v>1),
In one example, values of L, M, and D are the same for rank values.
In one example, values of L, M, and D are specific for a rank value.
In one example, L is specific for a rank value, and (M, D) is rank-common.
In one example, (M, D) is specific for a rank value, and L is rank-common.
In one example, M is specific for a rank value, and (L, D) is rank-common.
In one example, (L, D) is specific for a rank value, and M is rank-common.
In one example, D is specific for a rank value, and (L, M) is rank-common.
In one example, (L, M) is specific for a rank value, and D is rank-common.

In one embodiment, the (non-zero) coefficients from the coefficient matrix/vector C are quantized.
In one example, the quantization scheme is the same as in Rel-16 eType II codebook for amplitude and phase.
In one example, the quantization scheme is based on a uniform B bit quantizer, expecting the coefficients are real or real and imaginary parts (i.e. I/Q samples) are quantized separately.

In one embodiment, the data collection (based on the measurement at UE or/and gNB/RU/O-RU/PG) is according to at least one of the following examples.
In one example, the data collection is at a NW entity (e.g. O-CU, O-DU, or O-RU).
In one example, the data collection is at UE
Transparent
In one example, the data collection is at OAM (RAN3) which performs operations such as admin, maintenance.
In one example, the data collection is at OTT, a 3^{rd} party application for running AI/ML (getting data, modeling, and validation).

In one embodiment, for the use case of CSI reporting (as explained herein), the measurement and data collection is according to one of the following examples.
In one example, the model training is @ NW based on measurement of an RS.
   In one example, the RS is at least one UL RS (e.g. sounding reference signal (SRS)) measured by the NW (e.g. one or multiple O-RUs).
   In one example, the RS is at least one DL RS (e.g. NZP CSI-RS) measured by the UE, and the UE reports/provides the measurement data (CSI-RS measurement or CSI report) to NW (e.g. O-RU)·
In one example, the model training is @ UE NW based on measurement of an RS.
   In one example, the RS is at least on DL RS (e.g. CSI-RS).
   In one example, the RS is at least on UL RS (e.g. SRS) and NW (O-RU) providing data (based on SRS measurement) to UE.

In one embodiment, for the use case of CSI reporting (as explained herein), the model is one-sided, i.e., one of encoder (ENC) and decoder (DEC) is had. One side trains (e.g. W1) and transfers the model to the other side (e.g. offline).
In one example, the training is performed by NW and trained model is transferred to the UE.
In one example, the training is performed by UE and trained model is transferred to the NW.

In one embodiment, for the use case of CSI reporting (as explained herein), the model is two-sided, i.e. both ENC and DEC are had.
In one example, one side trains (e.g. NW or UE), keeps ENC and transfers DEC to the other side (e.g. offline).
In one example, each side trains its part, for example, the ENC side trains ENC and DEC side trains DEC.
   In one example, the training is performed by both NW and UE. For example, the ENC is trained at NW and DEC is trained at UE.

In one example, for a two-sided model, both sides (NW or UE) has the same (or same type of) model. In one example, for a two-sided model, two sides (NW or UE) can have their own model, implying the two models may be the same or different.

In one example, the model training can be performed offline (e.g., once) or online (e.g. multiple times). In one example, the training is offline for a static or pedestrian UE or fixed wireless access device (e.g. CSI). In one example, the training is online for UE mobility and beam.

In one embodiment, the model is a convolutional (CNN) or a Transformer, and the training is one of both of basis and coefficients of the dual-stage precoder.

A two-stage deep-learning precoding includes: (i) Stage 1 for set of basis entities (W1, Wf, Wd) and (ii) Stage 2 for set of coefficients W2. There can be two expectations regarding the antenna geometry/structure.
Expectation 1: dictated by spatial/frequency/time-domain (SD/FD/TD) properties→a fixed codebook suffices
Expectation 2: agnostic to (SD, FD, TD) properties→need for a learning-based (e.g. AI/ML, convolutional, non-DFT) codebook component

Here, (SD, FD, TD) properties can depend on antenna geometry and 2nd order channel stats etc.

Three examples of model type is shown in Table 6.

TABLE 6

| Example | Basis (W1, Wf, Wf) | W2 matrix |
|---|---|---|
| Example 1 | Fixed basis | Deep-learning based |
| | (e.g. DFT or Slepian) | |
| Example 2 | Deep-learning based | Fixed quantization |
| | | (CB-based) |
| Example 3 | Deep-learning based | Deep-learning based |

In Example 1, W1 is according to Expectation 1, implying that it can be CB-based, and W2 is according to Expectation 2, implying that it can be training-based (e.g. convolutional).
In Example 2, on the other hand, W1 is according to Expectation 2, implying that it can be learning-based e.g. Toeplitz (single, doubly), and W2 is according to Expectation 1, implying that it can be CB-based.
In Example 3, conversely, takes into account both W1 and W2 determination based on Expectation 1. One implementation here is W1 determination is cell/site-specific while W2 determination is cell/site/location agnostic, e.g., fully specified.

The DFT-based codebook can be used as fall-back and to initiate the precoding operation before switching to the leaning-based codebook.

The past decade has witnessed an explosion in use of AI techniques in areas such as image processing, text and speech, robotics, and wireless communications, as they can provide solutions to otherwise intractable and inherently hard problems. These techniques kick in when there are patterns/correlations in input data, but capturing them would require processing huge amount of data that almost include significant randomness and variations, something infeasible with non-AI techniques. They can also identify underlying function or relationship, which is usually difficult to model mathematically, between input and output based on a given data set. With AI, one can use available data to train models in order to learn to represent/predict/infer the “key” inherent feature/behavior in data. In a cellular system, AI is relevant for use cases such as CSI prediction, CSI compression, positioning, and beam management, focus of release (Rel)-18/19 study/work items in 3^{rd} generation partnership project (3GPP) [1]. In 6G, AI is going to be a pervasive/omni-present technology, termed as AI-native. In the context of 6G MIMO, AI-native, if used properly, offers a future-proof and versatile method for accommodating various deployment scenarios, reducing specification efforts on MIMO components (e.g. codebooks, multitude settings and types of CSI, beam measurement and reporting) via the use of non-parametric learning/training. In particular, AI-native CSI based on a scenario-driven learning-based codebook can be pivotal in 6G.

A channel usually has correlation across (SD, FD, TD), and thus statistical parameters of channel including large-scale parameters such as delay spread, Doppler spread, and angular spread can be trained/learnt via a two-sided neural network (NN) model, user-side auto-encoder and NW-side auto-decoder, and those trained statistical parameters can be used for CSI compression. The two sides of the model are coupled, and need to be trained jointly. This requires multi-vendor collaborations between different NW and user equipment (UE) vendors in data collection, model training, and inference phases, including model transfer and update, which entails various practical real-world challenges.

When the two-sided model is convolutional NN (CNN), each layer of the auto-encoder essentially is a Toeplitz/Circulant matrix, which acts as a deep-learning basis (W1), and the corresponding neurons act as coefficients (W2). The basis is learnt, and the coefficients are reported by the user. In [2], a CNN-based CSI compression in (SD, FD) is provided, but the provided model comprises as many as seven convolutional layers (besides additional layers for normalization, flattening etc.). For a UE, such an auto-encoder is too complex to be feasible in practice. A deep-learning-based joint source-channel encoding where the source is CSI and the model is one-sided (UE-side) is provided in [3]. While one-sided model and joint source-channel learning are plausible for a single link, it is unclear whether such models can be trained user-specifically for hundreds of users in a typical cellular deployment.

An AI-native CSI based on a dual-stage codebook structure is provided, with a scalable W1 based on a deep-learning-basis with fixed-basis for fallback/initialization, and a unified W2. The fixed-basis is discrete Fourier transform (DFT)-based, and the deep-learning-basis is a compact single-layer convolutional Kernel for SD/FD compression. The convolutional kernels are trained for each cell in a cellular region. For fixed-basis, Rel-16/18 single TRP (sTRP) Type II and Rel-18 multi-TRP (mTRP) CJT codebooks are used. For mTRP CJT, the convolutional kernels are trained for each candidate CJT set. The system-level performance benefits of the provided codebook are demonstrated for two example scenarios (sTRP and mTRP CJT), showing that significant gain in both performance and overhead is feasible. The baseline taken into account (for comparison) is Rel-16 Type II for sTRP scenario and Rel-18 Type II mTRP CJT for mTRP CJT scenario. In this disclosure, antenna port layout, TRP and open radio unit (O-RU) are used interchangeably.

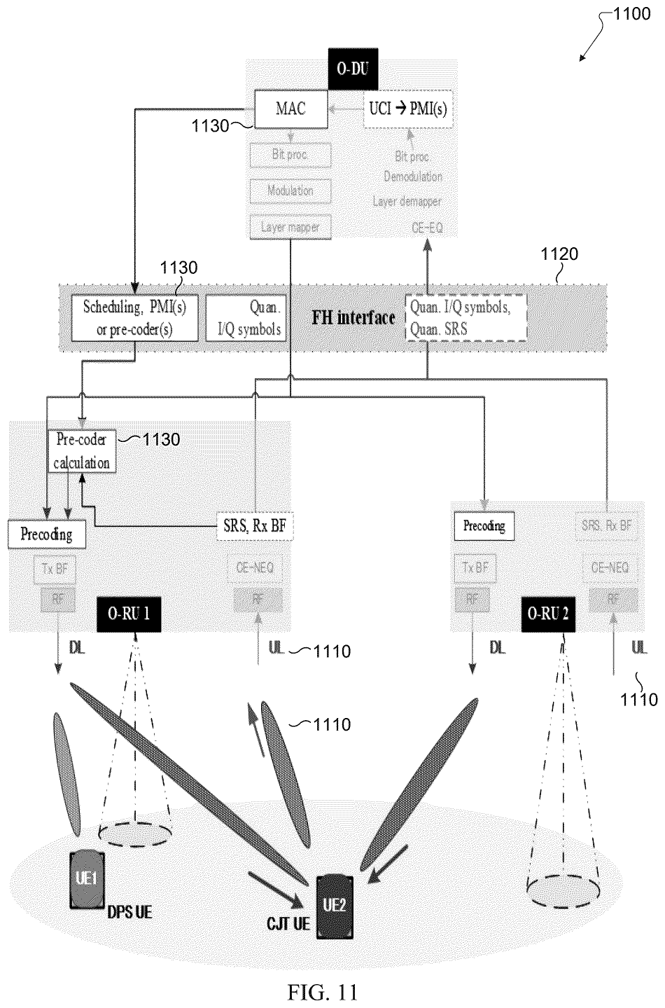

FIG. 11 illustrates an example O-RAN system 1100 according to embodiments of the present disclosure. For example, O-RAN system 1100 can be implemented by the UE 111, the UE 116, the gNB 102 and/or the network 130, and the gNB 103 and/or the network 130 in the wireless network 100 of FIG. 1. This example is for illustration only and other embodiments can be used without departing from the scope of the present disclosure.

The cellular industry has been shifting towards an open RAN (O-RAN) functionalities, distributed into centralized unit (O-CU), distributed unit (O-DU), and radio unit (O-RU), and fast fronthaul (FH) solutions to connect the units, such as enhanced common public radio interface (eCPRI), owing to multi-vendor ecosystems such as the O-RAN alliance and small-cell forum. This is evident from multi-vendor initiatives such as AT&T, Ericsson, and Fujitsu (US), Verizon, Samsung, and Keysight (US), Telus and Samsung (Canada), Vodafone and Samsung (Europe), NTT Docomo, NEC, Mavenir, and AWS (Japan), and Mavenir and Vodafone Idea (India). This trend is expected to grow continually within the next decade, aligned with 3GPP 6G timeline [4]. Therefore, an O-RAN-inspired NW architecture is inevitable for 6G. An example of O-RAN physical (PHY) layer split is illustrated in FIG. 11, where O-RU1 and O-RU2 connected to an O-DU serve UE1 and UE2. Here, UE2 transmits an uplink (UL) signal (1110), which passes RF and lower PHY operations in O-RU1 (on the left). The resultant I/Q symbols and sounding reference signal (SRS) measurement are quantized before transmitting over the FH interface (1120). The received signal is de-quantized then passed on to the O-DU, which performs high PHY operations to extract information bits including UL control information (UCI) carrying CSI. The medium access control (MAC) in O-DU then performs scheduling for UE1 and UE2, and communicates the scheduling and corresponding precoding information after quantization (1130) over the FH interface. For CJT UEs, UE2, the relevant scheduling and precoding information are also communicated to O-RU2 (not shown).

A distributed NW topology is expected to be at the core of 6G taking into account new/future market-needs and features in frequency range (FR) 1, FR2 and new bands (e.g. FR3). The cell-centric NW can still be supported as a specific configuration while a new (cell-free/boundary-less or user-centric) NW topology is introduced [5] [6]. Such NW topologies have been discussed (to some extent supported) in the past, e.g., dynamic point selection (DPS), coordinated scheduling/beamforming (CS/CB), NCJT, and CJT. Some of these are now feasible/implementable owing to distributing RAN functions into O-CU, O-DU, and O-RU. MIMO in a distributed NW setting is crucial to improve spectral efficiency, especially in frequency bands with limited BW. It is also expected that new antenna architectures (e.g. non-uniform) will be relevant in 6G. As an example, a radio stripe system has been introduced in [7] for TDD systems wherein the antenna elements and associated processing units are integrated inside multiple connected radio stripes, and thereby, a flexible deployment to attach irregular surfaces becomes feasible. Also, another practical architecture for FDD was introduced in [8], distributed massive MIMO using modular antenna structures, where several basic antenna modules are predefined and it is regarded that any combination of them can flexibly be deployed and connected to form a single MIMO system. MIMO with such flexible antenna structures requires an advanced, modular, and scalable framework than that for 5G in order to ensure efficient communication between the NW and the user.

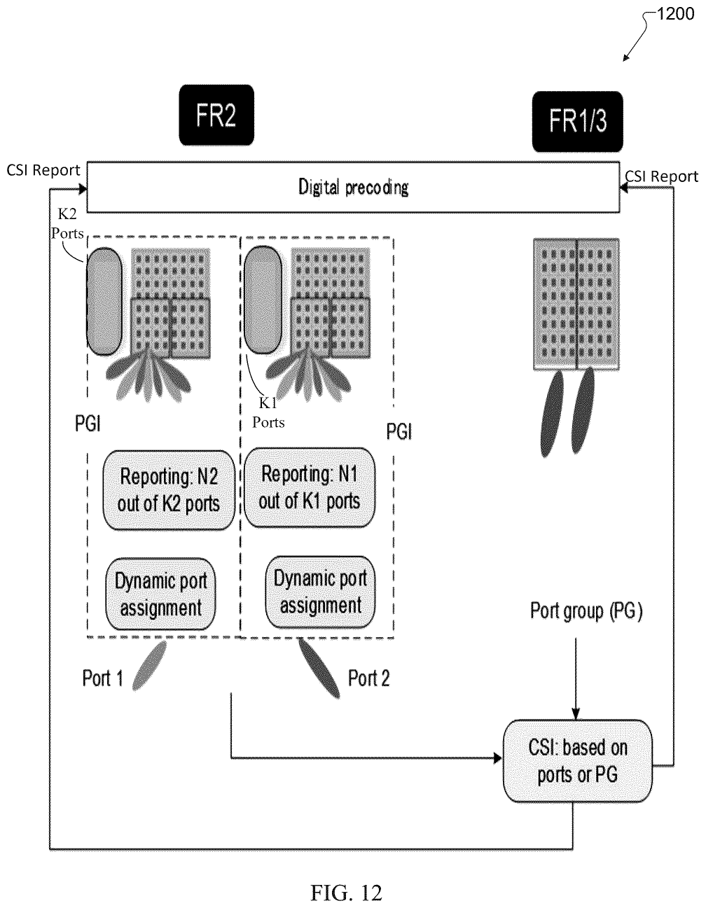

FIG. 12 illustrates an example PG 1200 according to embodiments of the present disclosure. For example, PG 1200 can be implemented in the network 130 and/or the BS 102 of FIG. 1. This example is for illustration only and other embodiments can be used without departing from the scope of the present disclosure.

A channel between the NW and the user can be characterized as resource units in spatial-domain, frequency-domain, and time-domain (SD, FD, TD). The SD units are associated with multiple ports or port groups (PGs), where ports/PGs can be co-located at a site/location or non-co-located/distributed at multiple sites/locations, aka centralized or distributed MIMO, respectively. For the purpose of DL CSI acquisition, a PG can be defined as a collection of N_{b}≥1 ports sharing a commonly configured set of properties (analogous to CSI-RS resource in 5G). This is instrumental in CSI reporting utilized for mTRP or multiple O-RUs (especially CJT) or virtual sectorization where a TRP or an O-RU or a virtual sector corresponds to a PG. The FD units comprise a set of subcarriers, and the TD units comprise one or multiple time slots (symbols). The communication hypothesis across ports/PGs can be non-coherent joint transmission (NCJT) where a data stream (layer) is transmitted from one of SD unit, or coherent JT (CJT) where a data stream (layer) can be transmitted from multiple of the SD units. An example of CSI framework is illustrated in FIG. 12.

For communication over the channel, CSI is acquired at the NW based on a CSI report by the user. To determine the CSI for reporting, the user measures channel measurement RSs (CMRs) to estimate the channel between the ports/PGs and the user. The user can be configured with one or multiple CMRs depending on deployment scenarios and transmission hypothesis. The user can also measure the interference based on interference measurement RSs (IMRs). In 5G, both a low-resolution (aka Type I) and a high-resolution (aka Type II) CSI (compressed in SD via SD basis comprising L SD vectors) are supported. The Type I CSI is based on L=1 DFT SD vector per layer, requires low feedback overhead and can work reasonably well for single user (SU)-MIMO. For multiuser-(MU-) MIMO transmission, however, Type II CSI capturing multiple dominant directions of the channel is essential in order to suppress MU interference. The Type II CSI is based on a weighted linear combination of L>1 SD DFT vectors where the weights correspond to coefficients [9]. The FD basis comprising MDFT vectors are additionally introduced to reduce the CSI payload by compressing CSI in both SD and FD. This 2D compression is extended further to CJT across multiple ports/PGs and to 3D (SD, FD, DD) compression using a DD basis comprising Q>1 DD vectors [10].

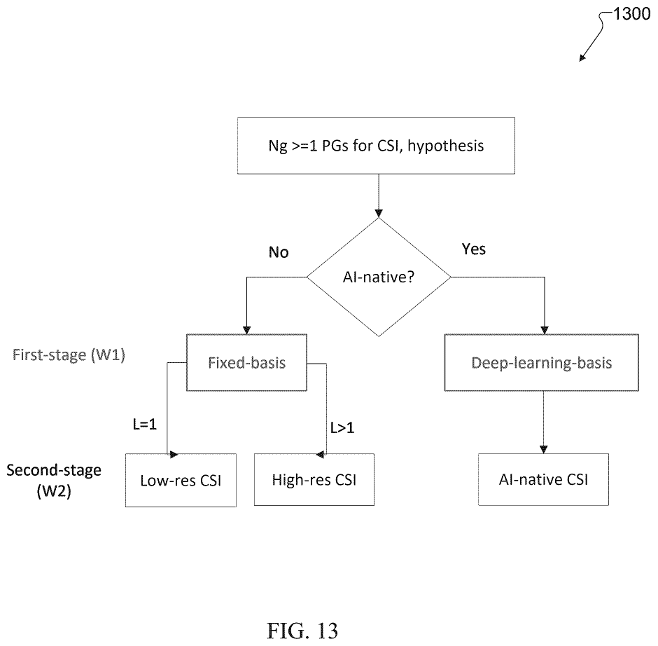

FIG. 13 illustrates an example codebook 1300 according to embodiments of the present disclosure. For example, codebook 1300 can be utilized by any of the UEs 111-116 of FIG. 1, such as the UE 112. This example is for illustration only and other embodiments can be used without departing from the scope of the present disclosure.

As discussed herein, a fixed codebook (expecting a uniform array and phase wave-front) is no longer sufficient in 6G due to (1) ‘new’ antenna types/architectures/geometries, (2) distributed (e.g. CJT), open (e.g. O-RAN), and “less”-structured (e.g. dynamic port adaptation for energy saving) NW topology, (3) dynamic duplexing (e.g. subband full duplex (SBFD), single frequency full duplex (SFFD)) operations, and advanced technologies such as RIS and near-field effects, and (4) new frequency bands with sparser (low-rank) channels (e.g. FR3) requiring mTRP-like MIMO operations. These necessitates a scenario-driven learning-based codebook-design. AI-native could be instrumental in this regard. For UE not capable of AI-native, the fixed-basis codebook can be used as a last resort as illustrated in FIG. 13.

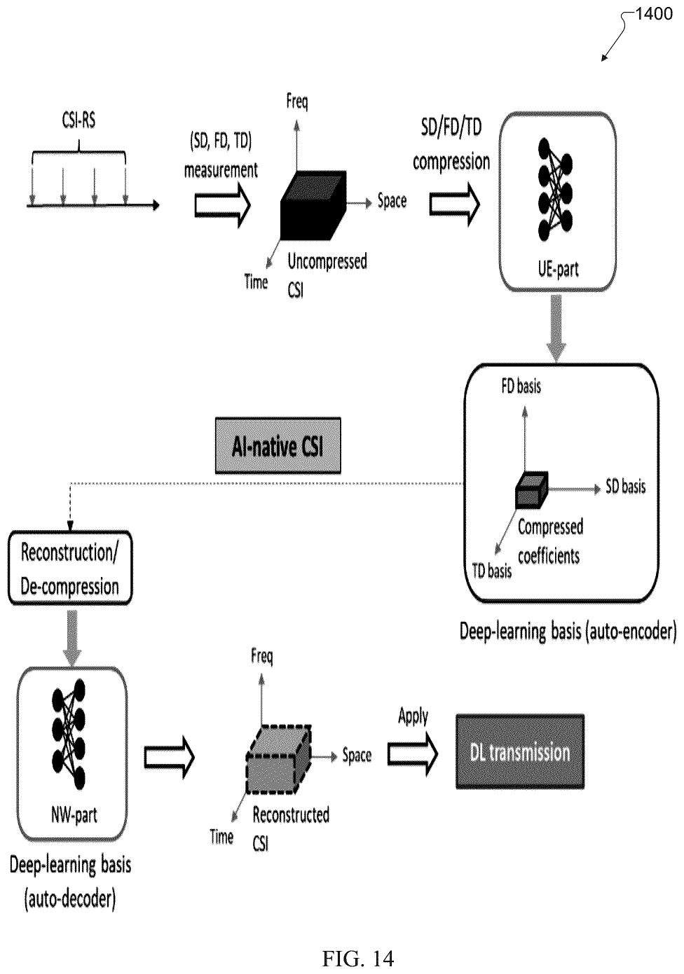

FIG. 14 illustrates an example AI-native CSI configuration 1400 according to embodiments of the present disclosure. For example, the UE 113 and the network 130 and/or the BS 103 of FIG. 1 can implement AI-native CSI configuration 1400. This example is for illustration only and other embodiments can be used without departing from the scope of the present disclosure.

In the provided AI-native CSI, the precoding is based on two stages: (i) first-stage for basis (W1) and (ii) second-stage for coefficients (W2). The first-stage includes a deep-learning-based basis, if the user is AI-native capable, and a unified fixed-basis, otherwise. The fixed-basis can also be used for fallback, initialization. An illustration of the AI-native CSI is shown in FIG. 14. The user measures CSI-RS and uses the measurement to determine uncompressed CSI. The CSI is then compressed in (SD, FD) or (SD, FD, DD), if DD compression is ON, utilizing the deep-learning-basis (auto-encoder). The compressed coefficients are then fed back as part of the AI-native CSI report. The deep-learning auto-decoder is then used to de-compress or reconstruct the CSI, which then is applied to subsequent downlink (DL) transmissions. The details of fixed- and deep-learning bases are provided next.

A unified fixed-basis “parameterized” codebook is provided based on parameters (L, M, Q) associated with (SD, FD, DD) bases, as tabulated in Table 7. When L=1, the codebook operates in a low-resolution (low-res) mode based on a single SD vector (per layer), and when L>1, the codebook corresponds to a high-resolution (high-res) mode based on a linear combination of multiple SD vectors (per layer). When M is not configured, there is no FD compression, hence the coefficients are reported for each SB in the CSI reporting band. When M is configured, there is FD compression (cf. Rel-16 eType II codebook in 5G). Likewise, when Q=1, there is no DD basis, i.e., DD compression is turned OFF. When Q>1, there is DD compression across DD units (cf. Rel-18 eType II-Doppler codebook in 5G). For multiple layers, each layer is encoded independently. In low-resolution mode, there is no compression in FD and DD.

TABLE 7

| | Fixed-basis (W1) | | |
|---|---|---|---|
| Mode | SD | FD | DD |
| Low-res | L = 1 (selection) | No | No |
| High-res | L > 1 (combination) | M > 1 | Q > 1: configurable |

The structure of the reported high-res precoders (representing channel eigenvectors) is given by a summation:

$$( DD compression ON ) : p = {\sum }_{i = 0}^{L - 1} {\sum }_{f = 0}^{M - 1} {\sum }_{d = 0}^{Q - 1} {B}_{i , f , d} {c}_{i , f , d} ,$$

$$( DD compression OFF ) : p = {\sum }_{i = 0}^{L - 1} {\sum }_{f = 0}^{M - 1} {B}_{i , f} {c}_{i , f} ,$$

where B_{i,f,d} indicates a (i, f, d)-th element of the basis in three dimensions, and c_{i,f,d} is the corresponding coefficient. For basis, orthogonal DFT vectors are used. The Rel-16 W2 quantization is used for coefficient reporting in high-res mode.

The low-res precoder is given by

$$p = {\sum }_{i = 0}^{L - 1} {B}_{i} \times {c}_{i} ,$$

where Bᵢ indicates an i-th element of the SD basis, and cᵢ is the co-phasing coefficient.

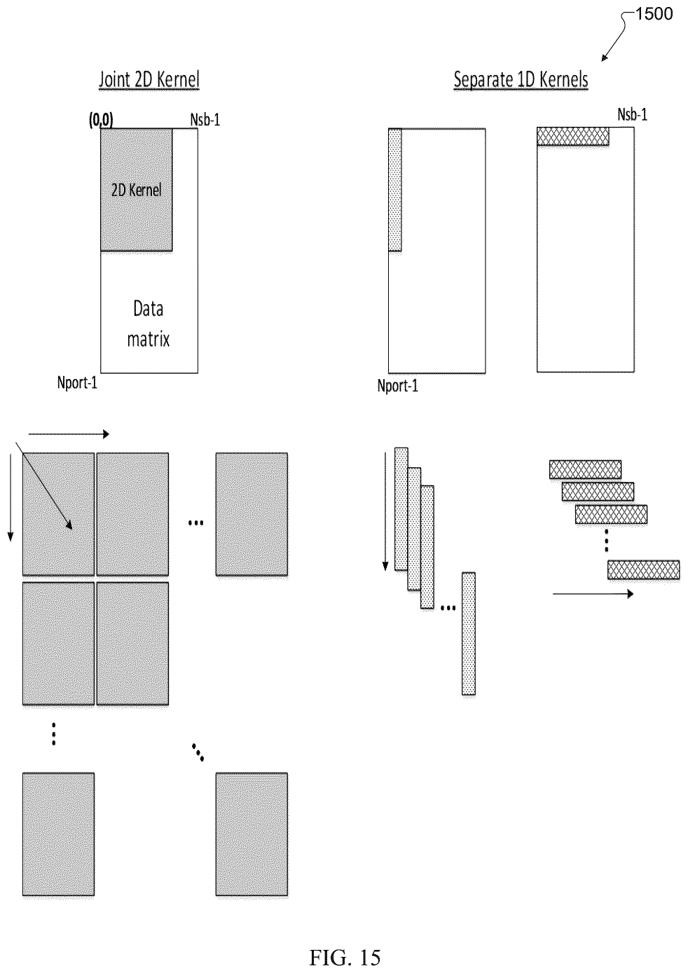

FIG. 15 illustrates examples of convolution configurations 1500 according to embodiments of the present disclosure. For example, convolution configurations 1500 can be utilized by the UE 114 of FIG. 1. This example is for illustration only and other embodiments can be used without departing from the scope of the present disclosure.

As antenna geometries get less-structured or more-distributed, (SD, FD, TD) properties can no longer be quantified with only fixed-basis, they rather need to be learnt depending on scenarios and deployments. Here, (SD, FD, TD) properties include antenna geometry, compression dimensions, SD/FD/TD units, prediction, and second order channel statistics. A convolutional (CNN)-based deep-learning basis is provided, replacing the fixed-basis. Mathematically, a one-dimensional (1D) convolution operation is equivalent to: A=KH_{data}, where K is a Toeplitz matrix and H_{data} is a data matrix, e.g. channel eigenvector matrix with columns being eigenvectors for N_{SB} SBs. For 2D (e.g. SD and FD), two separate ID convolutions are had, one for each dimension, or a joint 2D convolution, as shown in FIG. 15. Two separate ID convolutions is equivalent to:

$$A = {K}_{SD}^{H} {H}_{data} {K}_{FD} ,$$

where K_{SD} and K_{FD} are Toeplitz matrices for SD and FD, respectively. A single convolutional layer is used in order to keep the user complexity low. Also, a convolution operation can be based on a “full” (i.e. only full Toeplitz matrix is used) or “partial” (i.e. submatrices of the full Toeplitz matrix are also used in addition to the full matrix), where the partial kernels can be utilized to learn features around edges.

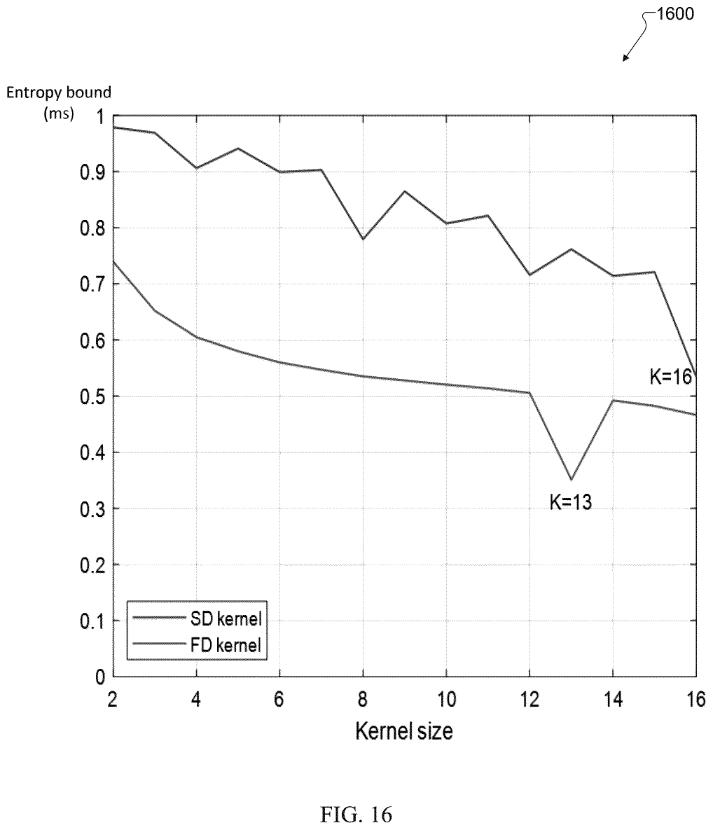

FIG. 16 illustrates an example entropy distribution 1600 according to embodiments of the present disclosure. For example, entropy distribution 1600 can be utilized by any of the UEs 111-116 of FIG. 1, such as the UE 114. This example is for illustration only and other embodiments can be used without departing from the scope of the present disclosure.

The purpose of learning the kernel is to be able to capture correlation or dependency across submatrices of the data matrix. To determine kernel size K, entropy of the distribution of the submatrices of chosen size can be used in Euclidean orthants as metric. Since lower entropy value indicates higher correlation between the components of the constructed submatrices, smaller the entropy higher the compression gain. Therefore, the kernel size K should achieve the minimum entropy value. FIG. 16 shows the entropy versus K for SD and FD kernels for the data matrix of size 32×13 (columns are eigenvectors). It is evident that K=16 and 13 respectively achieve the smallest entropy values, they can be chosen as SD and FD kernel sizes, respectively when the number of ports in 32 and number of SDs is 13.

The training for a two-sided model can be: (a) simultaneous/joint, or (b) sequential starting at one side and ending at another side. A small amount of data together with the trained one side of the two-sided model can be transferred to the other side of the two-sided model for training. Three types of data-driven training are as follows:
Offline training: training and inference at entities other than NW and user, e.g., training at external server.
Online training: training and inference on the same entity where model will be used, i.e., NW or/and user.
Federated learning: training across decentralized nodes (using local data) with orchestrating nodes, e.g. one or more users and NW node as an orchestrator.

Once trained, the model can be applied for a certain time period (depending on the channel variability), after which the model (in part or full) may need to be updated.

This refers to the model delivery procedure over the air interface, either parameters of a model structure known at the receiving end or a new model with parameters. Delivery may contain a full model or a partial model. When partial, the transfer is to facilitate training of the other side of the two-sided model.

For CSI compression, Nₚₒᵣₜ×N_{SB} matrices (length-Nₚₒᵣₜ eigenvectors for N_{SB} SBs) over a sufficiently large time duration are collected as data. Note that the two-sided model doesn't necessarily mean two-sided data collection and two separate model training. It merely means that each side has a model. Taking into account training complexity, the following data collection methods are preferred for a user.
Measurement by the user and data delivery to the NW
Dataset delivery from NW to user for sequential training.

In a cellular NW, a geographic region is covered by multiple cells and each cell serves several users. In this setting, the expected model for training can be one of: (a) cell-common, user-common (one model for users and cells), (b) cell-specific, user-common (one model for each cell, common for users in that cell), (c) user-specific (one model per user). Table 8 summarizes pros and cons of the three model types.

TABLE 8

| | Pros | Cons |
|---|---|---|
| (a) one model | Simple | Does not work in a real system when |
| | | number of users is large; |
| | | Requires data collection for NW-user |
| | | links, a challenge in practice |
| (b) one model | Intra-vendor; | Latency issue when frequent model |
| per cell | good | training/update is required |
| | performance | |
| (c) one model | Best- | Too many models; |
| per UE | performing | Severe latency issue in heavy |
| | | traffic scenarios or when frequent |
| | | model training/update is required |

The present disclosure relates generally to wireless communication systems and, more specifically, to Deep-learning-based precoding in next generation of communication (e.g. 6G) systems.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 9. Whenever the FR2 is referred, both FR2-1 and FR2-2 frequency sub-ranges shall be provided, unless otherwise stated.

TABLE 9
Definition of frequency ranges

| | Frequency range | | Corresponding |
|---|---|---|---|
| | designation | | frequency range |
| FR1 | | | 410 MHz-7125 MHz |
| | FR2 | FR2-1 | 24250 MHz-52600 MHz |
| | | FR2-2 | 52600 MHz-71000 MHz |

In next generation cellular standards (e.g. 6G), in addition to FR1 and FR2, new carrier frequency bands can be taken into account, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g. up to 256).

The 5G CSI is based on a fixed-basis codebook. The fixed-basis approach is unscalable and non-future-proof, since it requires specific designs tailored for CSI compression/resolution type, deployment scenario, transmission hypothesis, and operating carrier frequency, as is evident from close to two dozen codebooks specified in 5G. AI-native is expected to be an integral part of a 6G system, hence can be instrumental in designing a scenario-driven learning-based basis, whenever feasible, as a replacement for the fixed-basis. A few examples of AI-native CSI is provided in this disclosure.

The present disclosure describes several examples for learning-based (aka AI-native) CSI. Details on the support of these methods for generating/reporting CSI are disclosed, including information elements to be exchanged between a transmitter and a receiver. The following aspects are provided in the disclosure:
Examples of one-sided model
Examples of two-sided model
Link adaptation or CQI calculation/reporting
Signaling details

In one example, the antenna architecture of the MIMO system is structured. For example, the antenna structure at each PG or O-RU (or RU) is dual-polarized (single or multi-panel) as shown in FIG. 8. The antenna structure at each PG or O-RU (or RU) can be the same. Or, the antenna structure at an PG or O-RU (or RU) can be different from another PG or O-RU (or RU). Likewise, the number of ports at each PG (or O-RU or RU) can be the same. Or, the number of ports at one PG (or O-RU or RU) can be different from another PG (or O-RU or RU).

In another example, the antenna architecture of the MIMO system is unstructured. For example, the antenna structure at one PG (or O-RU or RU) can be different from another PG (or O-RU or RU).

A structured antenna architecture is provided in the rest of the disclosure. For simplicity, each PG (or O-RU or RU) is equivalent to a panel (cf. FIG. 8), although, an PG (or O-RU or RU) can have multiple panels in practice. The disclosure however is not restrictive to a single panel assumption at each PG (or O-RU or RU), and can easily be extended (covers) the case when an PG (or O-RU or RU) has multiple antenna panels.

In one embodiment, an PG (or O-RU or RU) constitutes (or corresponds to or is equivalent to) at least one of the following:
In one example, an PG or O-RU (or RU) corresponds to a TRP.
In one example, an PG or O-RU (or RU) corresponds to a CSI-RS resource. A UE (e.g., the UE 116) is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 9.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or, it can be indicated via a MAC CE. Or, it can be provided via a DCI field.

Likewise, the value of K can be configured, e.g. via higher layer RRC parameter. Or, it can be indicated via a MAC CE. Or, it can be provided via a DCI field.

In one example, K=N_{g}=X. The value of X can be configured, e.g. via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS}, tot=2KN1N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1, r=1), followed by CSI-RS ports of (p=0, r=2), followed by CSI-RS ports of (p=1, r=2), . . . , followed by CSI-RS ports of (p=0, r=N) followed by CSI-RS ports of (p=1, r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . , followed by CSI-RS ports of (p=0, r=N), and
then CSI-RS ports of (p=1, r=1) followed by CSI-RS ports of (p=1, r=1), . . . , followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS}, r=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁})+(N_{1,r}_{₂}, N_{2,r}_{₂})

The past decade has witnessed an explosion in use of AI techniques in areas such as image processing, text and speech, robotics, and wireless communications, as they can provide solutions to otherwise intractable and inherently hard problems. These techniques kick in when there are patterns/correlations in input data, but capturing them would require processing huge amount of data that almost include significant randomness and variations, something infeasible with non-AI techniques. They can also identify underlying function or relationship, which is usually difficult to model mathematically, between input and output based on a given data set. With AI, one can use available data to train models in order to learn to represent/predict/infer the “key” inherent feature/behavior in data. In a cellular system, AI is relevant for use cases such as CSI prediction, CSI compression, positioning, and beam management, focus of release (Rel)-18/19 study/work items in 3^{rd} generation partnership project (3GPP) [1]. In 6G, AI is going to be a pervasive/omni-present technology, termed as AI-native. In the context of 6G MIMO, AI-native, if used properly, offers a future-proof and versatile method for accommodating various deployment scenarios, reducing specification efforts on MIMO components (e.g. codebooks, multitude settings and types of CSI, beam measurement and reporting) via the use of non-parametric learning/training. In particular, AI-native CSI based on a scenario-driven learning-based codebook can be pivotal in 6G.

A channel usually has correlation across (SD, FD, TD), and thus statistical parameters of channel including large-scale parameters such as delay spread, Doppler spread, and angular spread can be trained/learnt via a two-sided neural network (NN) model, user-side auto-encoder and NW-side auto-decoder, and those trained statistical parameters can be used for CSI compression. The two sides of the model are coupled, and need to be trained jointly. This requires multi-vendor collaborations between different NW and user equipment (UE) vendors in data collection, model training, and inference phases, including model transfer and update, which entails various practical real-world challenges.

When the two-sided model is convolutional NN (CNN), each layer of the auto-encoder essentially is a Toeplitz/Circulant matrix, which acts as a deep-learning basis (W1), and the corresponding neurons act as coefficients (W2). The basis is learnt, and the coefficients are reported by the user.

In this disclosure, antenna port layout, TRP and open radio unit (O-RU) are used interchangeably.

As discussed herein, a fixed codebook (expecting a uniform array and phase wave-front) is no longer sufficient in 6G due to (1) ‘new’ antenna types/architectures/geometries, (2) distributed (e.g. CJT), open (e.g. O-RAN), and “less”-structured (e.g. dynamic port adaptation for energy saving) NW topology, (3) dynamic duplexing (e.g. SBFD, SFFD) operations, and advanced technologies such as RIS and near-field effects, and (4) new frequency bands with sparser (low-rank) channels (e.g. FR3) requiring mTRP-like MIMO operations. These necessitates a scenario-driven learning-based codebook-design. AI-native could be instrumental in this regard. For UE not capable of AI-native, the fixed-basis codebook can be used as a last resort as illustrated in FIG. 13.

In the provided AI-native CSI, the precoding is based on two stages: (i) first-stage for basis (W1) and (ii) second-stage for coefficients (W2). The first-stage includes a deep-learning-based basis, if the user is AI-native capable, and a unified fixed-basis, otherwise. The fixed-basis can also be used for fallback, initialization. An illustration of the AI-native CSI is shown in FIG. 14. The user measures CSI-RS and uses the measurement to determine uncompressed CSI. The CSI is then compressed in (SD, FD) or (SD, FD, DD), if DD compression is ON, utilizing the deep-learning-basis (auto-encoder). The compressed coefficients are then fed back as part of the AI-native CSI report. The deep-learning auto-decoder is then used to de-compress or reconstruct the CSI, which then is applied to subsequent downlink (DL) transmissions. The details of fixed- and deep-learning bases are provided next.

In one example, a unified fixed-basis can be based on a “parameterized” codebook based on parameters (L, M, Q) associated with (SD, FD, DD) bases, as tabulated in Table 10. When L=1, the codebook operates in a low-resolution (low-res) mode based on a single SD vector (per layer), and when L>1, the codebook corresponds to a high-resolution (high-res) mode based on a linear combination of multiple SD vectors (per layer). When M is not configured, there is no FD compression, hence the coefficients are reported for each SB in the CSI reporting band. When M is configured, there is FD compression (cf. Rel-16 eType II codebook in 5G). Likewise, when Q=1, there is no DD basis, i.e., DD compression is turned OFF. When Q>1, there is DD compression across DD units (cf. Rel-18 eType II-Doppler codebook in 5G). For multiple layers, each layer is encoded independently. In low-resolution mode, there is no compression in FD and DD.

TABLE 10

| | Fixed-basis (W1) | | |
|---|---|---|---|
| Mode | SD | FD | DD |
| Low-res | L = 1 (selection) | No | No |
| High-res | L > 1 (combination) | M > 1 | Q > 1: configurable |

The structure of the reported high-res precoders (representing channel eigenvectors) is given by a summation:

$$( DD compression ON ) : p = {\sum }_{i = 0}^{L - 1} {\sum }_{f = 0}^{M - 1} {\sum }_{d = 0}^{Q - 1} {B}_{i , f , d} {c}_{i , f , d} ,$$

$$( DD compression OFF ) : p = {\sum }_{i = 0}^{L - 1} {\sum }_{f = 0}^{M - 1} {B}_{i , f} {c}_{i , f} ,$$

where B_{i,f,d} indicates a (i, f, d)-th element of the basis in three dimensions, and c_{i,f,d} is the corresponding coefficient. For basis, orthogonal DFT vectors are used. The Rel-16 W2 quantization is used for coefficient reporting in high-res mode.

The low-res precoder is given by

$$p = {\sum }_{i = 0}^{L - 1} {B}_{i} \times {c}_{i} ,$$

where Bᵢ indicates an i-th element of the SD basis, and cᵢ is the co-phasing coefficient.

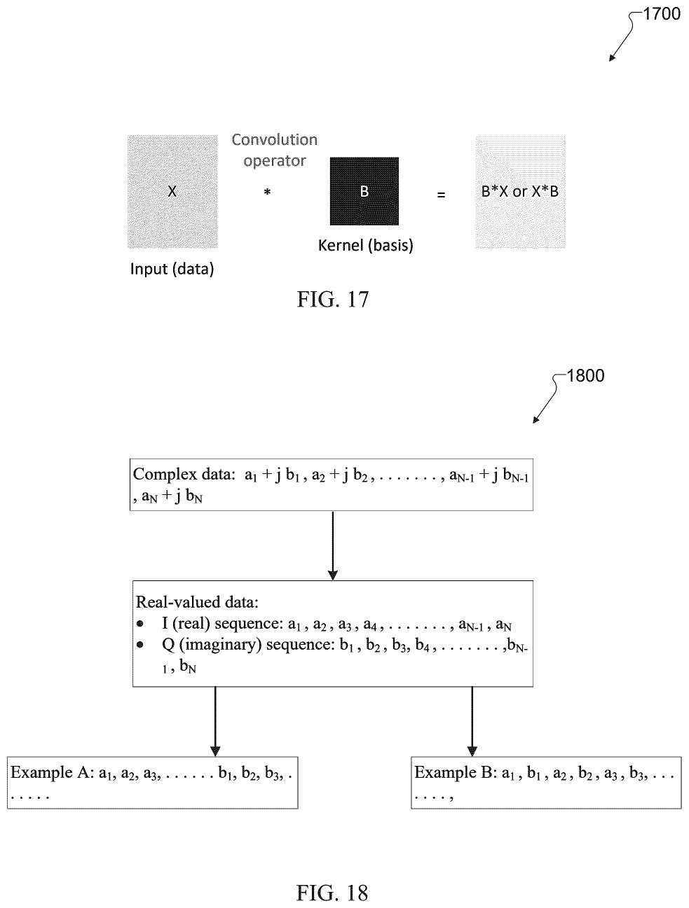

FIG. 17 illustrates an example convolution operation 1700 according to embodiments of the present disclosure. For example, convolution operation 1700 can be utilized by any of the UEs 111-116 of FIG. 1, such as the UE 115. This example is for illustration only and other embodiments can be used without departing from the scope of the present disclosure.

As antenna geometries get less-structured or more-distributed, (SD, FD, TD) properties can no longer be quantified with only fixed-basis, they rather need to be learnt depending on scenarios and deployments. Here, (SD, FD, TD) properties include antenna geometry, compression dimensions, SD/FD/TD units, prediction, and second order channel statistics. One can adopt a learning-based, e.g. a convolutional (CNN)-based deep-learning basis replacing the fixed-basis. Mathematically, a one-dimensional (1D) convolution operation is equivalent to: A=KH_{data}, where K is a Toeplitz matrix and H_{data} is a data matrix, e.g. channel eigenvector matrix with columns being eigenvectors for N_{SB} SBs. For 2D (e.g. SD and FD), two separate 1D convolutions can be had, one for each dimension, or a joint 2D convolution, as shown in FIG. 15. Two separate ID convolutions is equivalent to: A=K_{SD}^{H}H_{data} K_{FD}, where K_{SD} and K_{FD} are Toeplitz matrices for SD and FD, respectively. A single convolutional layer is provided in order to keep the user complexity low. Also, a convolution operation can be based on a “full” (i.e. only full Toeplitz matrix is used) or “partial” (i.e. submatrices of the full Toeplitz matrix are also used in addition to the full matrix), where the partial kernels can be utilized to learn features around edges. The matrix K or matrices (K_{SD}, K_{FD}) are constructed based on a Kernel (basis) B. An example of the convolution operation on input data X=H_{data} by Kernel (basis) B is shown in FIG. 17.

In approach 1, as in 5G system, the link adaptation (e.g. modulation and coding scheme (MCS) selection) for a scheduled DL (PDSCH) transmission is based on a CQI. When CQI is acquired via a CSI report, the UE is configured to calculate CQI conditioned on rank or RI (e.g. non-PMI CSI report in TDD systems) or conditioned on both RI and PMI (e.g. in FDD systems). In particular, the UE calculates CQI assuming precoder/rank as indicated via PMI/RI. For SB CQI reporting, the UE calculates a CQI value for each SB in the CSI reporting band. The CQI value can be calculated based on a SINR value

$$\frac{S}{I + N} ,$$

where (i) signal quality(S) is based on desired channel measurement (e.g. CMR such as NZP CSI-RS), and (ii) interference level (I) is based on interference measurement (e.g. IMR such as CSI-IM or ZP CSI-RS).

In approach 2, the NW can acquire/determine CQI based on SINR which can be calculated based on acquiring (i) S and (ii) I. The S can be acquired via SRS measurement (e.g. in TDD systems) or/and via CSI-RS measurement and CSI feedback (e.g. PMI or explicit channel feedback). The I can be acquired via IMR measurement and interference feedback.

In an AI-native CSI, the approach may fail for CQI calculation. In particular, when the AI-native CSI is based on a one-sided (auto-) encoder (AE) model for PMI, the UE determines the PMI based on the output of the AE. When the NW can essentially perform inverse of the AE operations on the received PMI, the CQI calculation can be conditioned on the AE, e.g. input or/and output to the AE (e.g. eigenvectors or channel) and interference measurement. Else (when NW can't perform inverse of the AE operations on the received PMI), the CQI can be based on approach 1 or approach 2.

When the AI-native CSI is based on a two-sided model with a UE-side AE and a NW-side auto-decoder (AD), the CQI should be conditioned on both AE and AD. When the UE does not know the NW-side AD (which is likely in practice), the UE may not be able to calculate CQI conditioned on AE and AD. In this case, an alternate mechanism to calculate CQI is needed. A few examples are provided herein.

In one embodiment, the CQI calculation can be conditioned on a nominal (or reference or specified or configured) AD for CQI calculation purpose. In particular, the UE can be fixed (e.g. in the specification), or configured with an information about the nominal AD. The configuration can be via RRC or via system information (e.g. SIB1) in broadcast channel.
In one example, the nominal AD can be a CNN with one or more layers. Each layer can include a normalization (e.g. batch normalization) or/and non-linear (NL) layers (e.g. rectified linear unit (ReLU) or leaky ReLU).
the nominal AD can be a long-short-term memory (LSTM) NN with one or more layers. Each layer can include a normalization (e.g. batch normalization) or/and non-linear (NL) layers (e.g. ReLU).
the nominal AD can be a convolutional LSTM (conv-LSTM) NN with one or more layers. Each layer can include a normalization (e.g. batch normalization) or/and non-linear (NL) layers (e.g. ReLU).
the nominal AD can be a transformer NN with one or more layers. Each layer can include a normalization (e.g. batch normalization) or/and non-linear (NL) layers (e.g. ReLU).

In one embodiment, the CQI calculation assumes a one-sided approach even for the case of the two-sided model for PMI. In one example, PMI is based on a two-sided model, and the CQI assumes a one-sided model.
In one example, the model for CQI calculation can be based on the two-sided model for PMI. For example, the AE and a fixed AD (e.g. based on the inverse of AU operations) can be used for CQI.
In one example, the model for CQI calculation can be a dedicated AE model for CQI (different from the model for PMI).

In one embodiment, the CQI calculation is based on a non-AIML PMI codebook (e.g. Type I or Type II PMI codebooks in 5G NR, as specified in TS 38.215).

In one embodiment, the CQI calculation is based on a non-AIML approach, and is non-codebook-based. For example, it can be based on channel information and interference information acquisition at the NW, as described herein. The NW can acquire channel information based on UL SRS measurement (e.g. in TDD scenarios) or/and channel/eigenvector/PMI feedback from the UE. The interference information can be based on feedback from the UE.

In one embodiment, the CQI calculation is based on explicit channel and interference feedback. The NW determines CQI.
In one example, both channel and interference can be AIML based.
   In one example, models for both channel and interference can be two-sided.
   In one example, channel can be two-sided, and interference can be one-sided.
   In one example, channel can be one-sided, and interference can be two-sided.
   In one example, models for both channel and interference can be one-sided.
In one example, the channel can be AIML based, and interference can be non-AIML (CB) based.

FIG. 18 illustrates an example complex-values matrix/vector 1800 according to embodiments of the present disclosure. For example, complex-values matrix/vector 1800 can be utilized by any of the UEs 111-116 of FIG. 1, such as the UE 116. This example is for illustration only and other embodiments can be used without departing from the scope of the present disclosure.

In one example, the input X is a complex-valued matrix (or vector). In one example, the input X is a real-valued matrix (or vector), which is formed by concatenation of real and imaginary parts of complex data values. At least one of the following examples shown in FIG. 18 is used for the concatenation.

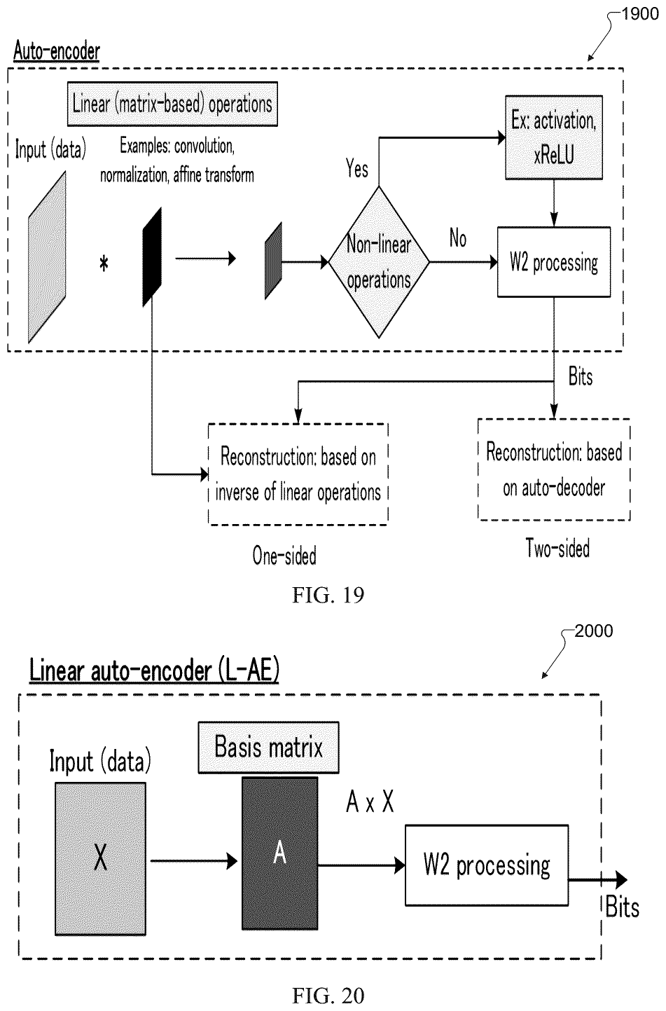

FIG. 19 illustrates an example NN-based AE 1900 according to embodiments of the present disclosure. For example, the UE 116 of FIG. 3 can be configured to use the NN-based AE 1900. This example is for illustration only and other embodiments can be used without departing from the scope of the present disclosure.

In one embodiment, as shown in FIG. 19, a UE (e.g., the UE 116) is configured to use a neural network (NN)-based auto-encoder (AE) model to determine a CSI, where the CSI is based on compression in at least one of SD, FD, and DD. The AE takes an input (data), e.g. eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI.

In one embodiment, the model for CSI compression is one-sided, i.e., AE only. That is, there is no associated NN-based auto-decoder (AD) needed at the gNB (e.g., the BS 102) to reconstruct the CSI. In one example, the one-sided model is downloadable, hence can be referred to as a downloadable codebook.

In one example, the one-sided model used for CSI compression is downloadable (e.g. via RRC or broadcast message). The UE is configured to use the one-sided model to determine CSI for reporting. The NW receives the CSI and performs necessary operations to reconstruct the CSI. For instance, the necessary operations can correspond to inverse of operations performed in the one-sided model. The one-sided model includes at least one of the following.
A linear operation, for example, via at least one matrix W_{L}.
A non-linear (NL) operation, for example, via at least one NL function f_{NL} ( ).
A normalization operation, for example, via at least one matrix Wₙₒᵣₘ.

Let W₁ denote the operations performed on the input CSI X.

In one example, the one-sided model includes a linear operation W_{L}. In this case, W₁=W_{L}X.
In one example, the linear operation W_{L} is based on principle components (PCs) of a KL transform on the input X. The decoder performs an inverse e.g. a pseudo inverse to reconstruct the reported CSI. The inverse can correspond to an inverse of PCs or an inverse KL transform.

In one example, the one-sided model includes a non-linear operation f_{NL} ( ). In this case, W₁=f_{NL} (X).

In one example, the one-sided model includes a normalization operation Wₙₒᵣₘ. In this case, W₁=WₙₒᵣₘX.

In one example, the one-sided model includes W_{L} and Wₙₒᵣₘ. In this case, W₁=Wₙₒᵣₘ W_{L}X.

In one example, the one-sided model includes W_{L} and f_{NL}. In this case, W₁=W_{L}f_{NL}(X) or f_{NL} (W_{L}X).

In one example, the one-sided model includes Wₙₒᵣₘ and f_{NL}. In this case, W₁=Wₙₒᵣₘf_{NL} (X) or f_{NL}(WₙₒᵣₘX).

In one example, the one-sided model includes W_{L}, Wₙₒᵣₘ and f_{NL}. In this case, W₁=Wₙₒᵣₘ W_{L}f_{NL} (X) or Wₙₒᵣₘf_{NL} (W_{L}X) or f_{NL} (Wₙₒᵣₘ W_{L}X).

In one example, the one-sided (or downloadable) model can be configured to the UE via an RRC connection. As the UE connects (or moves) to a cell, the UE is provided with the corresponding one-sided model for the cell.

In one example, when the one-sided (or downloadable) model is cell-specific, the trained model (codebook) can be configured to UEs within the cell via an information in the Broadcast channel, e.g. SIB1.

In one example, when the one-sided (or downloadable) model is UE-specific, the trained model (codebook) can be configured to UEs via UE-specific RRC messages.

In one example, the trained model (codebook) can be configured to UEs via a combination of cell-specific and UE-specific (e.g. SIB1 and RRC) signaling. In one example, the cell-specific part of the configuration corresponds to a set/pool S of one-sided models or at least one component of the one-sided model. The UE-specific part selects/indicates a subset Sy from the set S to a UE u. The subset Su can be different or same across UEs.

FIG. 20 illustrates an example linear AE 2000 according to embodiments of the present disclosure. For example, any of the UEs 111-116 of FIG. 1 can be configured to use the linear AE 2000. This example is for illustration only and other embodiments can be used without departing from the scope of the present disclosure.

In one example, the one-sided AE includes linear components such as a dense layer based on a matrix multiplication, as shown in FIG. 20, wherein the input X is processed linearly via a matrix A whose output (column) dimension is set according to the desired CSI compression (number of bits or number of reported neurons/coefficients). The resultant A×X coefficients are quantized via W2 processing block. This block can be according to the W2 quantization scheme of Rel-16 NR eType II codebook. This AE can be parameterized by parameter(s) P according to at least one of the following examples:
In one example, P includes size/dimension of X and A, i.e., P={a, b, c} or {(a, b), (b, c)} or {(a, b), (c, d)} where a×b is the size/dimension of Xand b×c or c×d is the size/dimension of A. The number of reported coefficients K^{NZ}≤c or d.
In one example, P includes (a) size/dimension of X and (b) number of coefficients (K^{NZ}) to be reported, i.e., P={a, b, K^{NZ}} where a×b is the size/dimension of X.
In one example, P includes size/dimension of X, A, and number of coefficients (K^{NZ}), i.e., P={a, b, c, K^{NZ}} or {(a, b), (b, c), K^{NZ}} or {(a, b), (c, d), K^{NZ}}. Here, K^{NZ}≤c or d.

When X comprises precoding (eigen) vectors and number of layers (rank)>1, P can be common (the same) for each layer, or P includes parameter(s) specific for each layer.

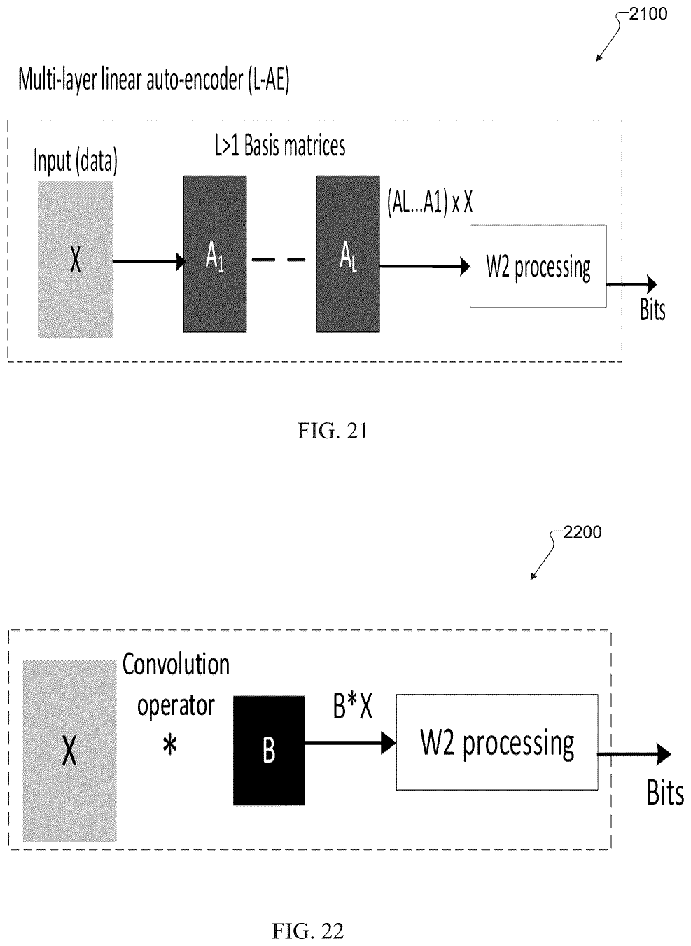

FIG. 21 illustrates an example multi-layer AE 2100 according to embodiments of the present disclosure. For example, any of the UEs 111-116 of FIG. 1, such as the UE 111, can be configured to use the multi-layer AE 2100. This example is for illustration only and other embodiments can be used without departing from the scope of the present disclosure.

In one example, an extension to multiple (L>1) layers is shown in FIG. 21, wherein there are basis matrices A₁, . . . , A_{L} of appropriate dimensions such that the overall basis is a multiplication A=A_{L}× . . . ×A₁. Let aᵢ×bᵢ is the size of matrix Aᵢ, where i=1, . . . , L. In one example, bᵢ₋₁=aᵢ for i≥2. This AE can be parameterized by parameter(s) P according to at least one of the following examples:
In one example, P includes size/dimension of X and {Aᵢ}, i.e., P={p, a₁, b₁, b₂, . . . b_{L}} or {(p, a₁), (a₁, b₁), (b₁, b₂), . . . } where p×a₁ is the size/dimension of X and a₁×b₁, b₁×b₂, . . . are the size/dimensions of A₁, . . . . A_{L}. The number of reported coefficients K^{NZ}≤b_{L}.
In one example, P includes (a) size/dimension of X and (b) number of coefficients (K^{NZ}) to be reported, i.e., P={a, b, K^{NZ}} where a×b is the size/dimension of X. The size of A=A_{L}× . . . ×A₁ is b×K^{NZ}.

In one example, P includes size/dimension of X, {Aᵢ}, and number of coefficients (K^{NZ}), i.e., P={p, a₁, b₁, b₂, . . . b_{L}, K^{NZ}} or {(p, a₁), (a₁, b₁), (b₁, b₂), . . . , K^{NZ}}. Here, K^{NZ}≤b_{L}.

FIG. 22 illustrates an example linear AE 2200 according to embodiments of the present disclosure. For example, any of the UEs 111-116 of FIG. 1, such as the UE 112, can be configured to use the linear AE 2200. This example is for illustration only and other embodiments can be used without departing from the scope of the present disclosure.

In one example, the one-sided AE includes linear components such as convolution operation (*), as shown in FIG. 22, wherein the input X is convolved (or convoluted) in SD or/and FD using a kernel (basis) matrix B. As described herein, the matrix B can be a two-dimensional (2D) matrix, or a pair B=(B_{row}, B_{col}) of one-dimensional (1D) vectors associated with row and column of the input. The output of the convolution operation B*X is set according to the desired CSI compression (number of bits or number of reported neurons/coefficients). The resultant B*X coefficients are quantized via W2 processing block. This block can be according to the W2 quantization scheme of Rel-16 NR eType II codebook. This AE can be parameterized by parameter(s) P according to at least one of the following examples:
In one example, P includes size/dimension of X and the Kernel B, i.e., P={a, b, c, d} or {(a, b), (c, d)} where a×b is the size/dimension of Xand c×d is the size/dimension of B. The number of reported coefficients K^{NZ}≤e where e is the number of entries of the convolved output Z=B*X (or X*B). In one example, e=ab (e.g. when there are zero padding around the input X). In one example, e=(a+c−1) (b+d−1) (e.g., when there is no zero padding around X. In one example, (a+c−1) (b+d−1)≤e≤ab depending on whether there is no zero padding, or when there is zero padding, the amount of zero padding.
In one example, P includes (a) size/dimension of X and (b) number of coefficients (K^{NZ}) to be reported, i.e., P={a, b, K^{NZ}} where a×b is the size/dimension of X, and K^{NZ}≤e with (a+c−1) (b+d−1)≤e≤ab, and c and d respectively are kernel size in the first (row) and second (column) dimensions of X.

In one example, P includes (a) size/dimension of X, and the Kernel B and (b) number of coefficients (K^{NZ}) to be reported.

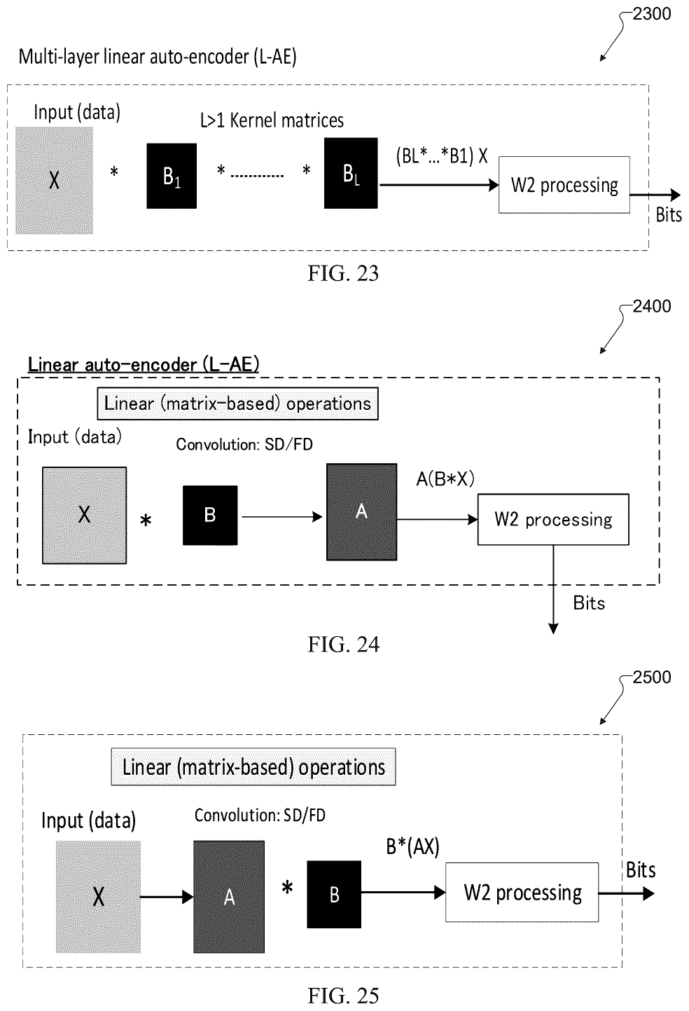

FIG. 23 illustrates an example multi-layer linear AE 2300 according to embodiments of the present disclosure. For example, any of the UEs 111-116 of FIG. 1, such as the UE 113, can be configured to use the multi-layer linear AE 2300. This example is for illustration only and other embodiments can be used without departing from the scope of the present disclosure.

In one example, an extension to multiple (L>1) layers is shown in FIG. 23, wherein there are Kernel matrices B₁, . . . , B_{L} of appropriate dimensions such that the overall Kernel is a sequence of convolution operations B=B_{L}* . . . *B₁.

FIG. 24 illustrates linear AE 2400 according to embodiments of the present disclosure. For example, any of the UEs 111-116 of FIG. 1, such as the UE 114, can be configured to use the linear AE 2400. This example is for illustration only and other embodiments can be used without departing from the scope of the present disclosure.

In one example, the one-sided AE includes linear components such as convolution operation (*) and matrix multiplication, as shown in FIG. 24 wherein the input X is convolved (or convoluted) in SD or/and FD using a kernel (basis) matrix B. As described herein, the matrix B can be a two-dimensional (2D) matrix, or a pair B=(B_{row}, B_{col}) of one-dimensional (1D) vectors associated with row and column of the input. The output of the convolution operation B*X is then processed linearly via a matrix A whose output (column) dimension is set according to the desired CSI compression (number of bits or number of reported neurons/coefficients). The resultant A (B*X) coefficients are quantized via W2 processing block. This block can be according to the W2 quantization scheme of Rel-16 NR eType II codebook.

FIG. 25 illustrates linear AE 2500 according to embodiments of the present disclosure. For example, any of the UEs 111-116 of FIG. 1, such as the UE 115, can be configured to use the linear AE 2500. This example is for illustration only and other embodiments can be used without departing from the scope of the present disclosure.

Alternatively, in one example, as shown in FIG. 25 the convolution and matrix multiplication operations can be swapped. In the rest of the disclosure, the former (convolution followed by multiplication) is expected. The examples/embodiments however are general and apply to the latter (multiplication followed by convolution).

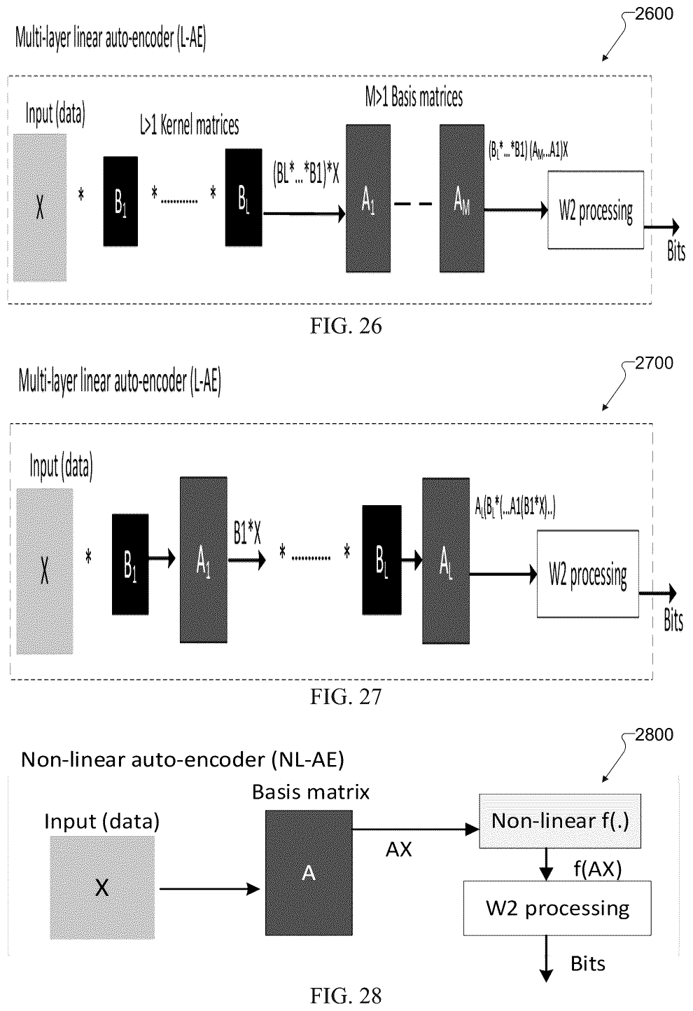

FIG. 26 illustrates an example multi-layer AE 2600 according to embodiments of the present disclosure. For example, any of the UEs 111-116 of FIG. 1, such as the UE 116, can be configured to use the multi-layer AE 2600. This example is for illustration only and other embodiments can be used without departing from the scope of the present disclosure.

FIG. 27 illustrates an example multi-layer AE 2700 according to embodiments of the present disclosure. For example, the UE 116 of FIG. 3 can be configured to use the multi-layer AE 2700. This example is for illustration only and other embodiments can be used without departing from the scope of the present disclosure.

In one example, an extension to multiple layers is shown in FIG. 26, wherein there are Kernel matrices B₁, . . . , B_{L} and basis matrices A₁, . . . , A_{L} of appropriate dimensions such that the overall Kernel or/and basis is a sequence of convolution operations B=B_{L}* . . . *B₁ followed by a multiplication A=A_{L}× . . . × A₁. In one example, L=1, M>1. In one example, L>1, M=1. In one example, L>1, M>1. In one example, L=M>1.

Another example is shown in FIG. 27, wherein L=M.

FIG. 28 illustrates an example NL-AE 2800 according to embodiments of the present disclosure. For example, any of the UEs 111-116 of FIG. 1, such as the UE 111, can be configured to use the NL-AE 2800. This example is for illustration only and other embodiments can be used without departing from the scope of the present disclosure.

In one example, the one-sided AE includes linear components such matrix multiplication, as well as at least one non-linear (NL) component (or activation function), as shown in FIG. 28, wherein the input X is processed linearly via a matrix A whose output is passed to a non-linear activation function/block (e.g. ReLU). The output dimension is set according to the desired CSI compression (number of bits). The resultant f_{NL} (AX) coefficients are quantized via W2 processing block. This block can be according to the W2 quantization scheme of Rel-16 NR eType II codebook.

In one example, the input or/and output of the NL layer is/are normalized. This normalization can be in 1D (e.g. for vector, or either row-wise or/and column-wise of a 2D matrix). Or, this normalization can be in 2D, e.g. across a 2D matrix.). Or, this normalization can be in 3D, e.g. across a 3D matrix (e.g. when input or output is a 3D tensor). This type of normalization can be referred to as “linear or block normalization.

In one example, when input or/and output is/are multi-dimensional (K≥2 dimensions), a subset (k<K) of the K dimensions of the input or/and output of the NL layer is/are normalized. The remaining K-k dimensions are not normalized. This type of normalization can be referred to as “layer normalization.

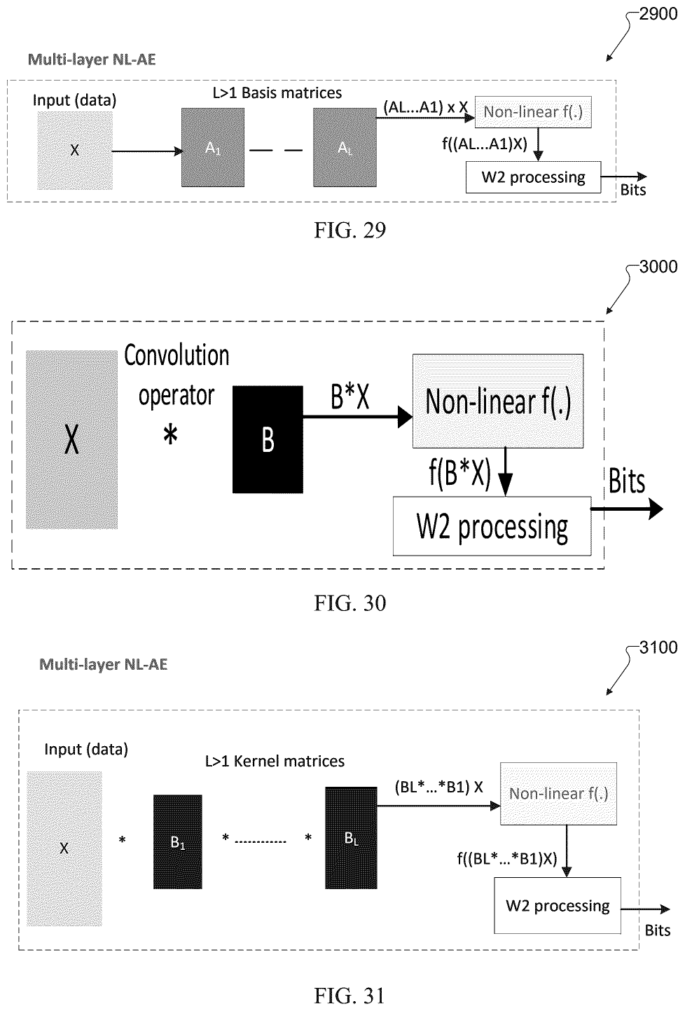

FIG. 29 illustrates an example multi-layer NL-AE 2900 according to embodiments of the present disclosure. For example, any of the UEs 111-116 of FIG. 1, such as the UE 112, can be configured to use the multi-layer NL-AE 2900. This example is for illustration only and other embodiments can be used without departing from the scope of the present disclosure.

In one example, an extension to multiple (L>1) layers is shown in FIG. 29, wherein there are basis matrices A₁, . . . , A_{L} of appropriate dimensions such that the overall basis is a multiplication A=A_{L}× . . . ×A₁. This AE can be parameterized by parameter(s) P according to at least one of the following examples:

FIG. 30 illustrates an example multi-layer NL-AE 3000 according to embodiments of the present disclosure. For example, any of the UEs 111-116 of FIG. 1, such as the UE 113, can be configured to use the multi-layer NL-AE 3000. This example is for illustration only and other embodiments can be used without departing from the scope of the present disclosure.

In one example, the one-sided AE includes linear components such as convolution operation (*) as well as at least one non-linear (NL) component (or activation function), as shown in FIG. 30, wherein the input X is convolved (or convoluted) in SD or/and FD using a kernel (basis) matrix B whose output is passed to a non-linear activation function/block (e.g. ReLU). As described herein, the matrix B can be a two-dimensional (2D) matrix, or a pair B=(B_{row}, B_{col}) of one-dimensional (1D) vectors associated with row and column of the input. The output dimension is set according to the desired CSI compression (number of bits or number of reported neurons/coefficients). The resultant f(B*X) coefficients are quantized via W₂ processing block. This block can be according to the W₂ quantization scheme of Rel-16 NR eType II codebook.

FIG. 31 illustrates an example multi-layer NL-AE 3100 according to embodiments of the present disclosure. For example, any of the UEs 111-116 of FIG. 1, such as the UE 114, can be configured to use the multi-layer NL-AE 3100. This example is for illustration only and other embodiments can be used without departing from the scope of the present disclosure.

In one example, an extension to multiple (L>1) layers is shown in FIG. 31, wherein there are Kernel matrices B₁, . . . , B_{L} of appropriate dimensions such that the overall Kernel is a sequence of convolution operations B=B_{L}* . . . *B₁. AE can be parameterized by parameter(s) P according to at least one of the following examples:

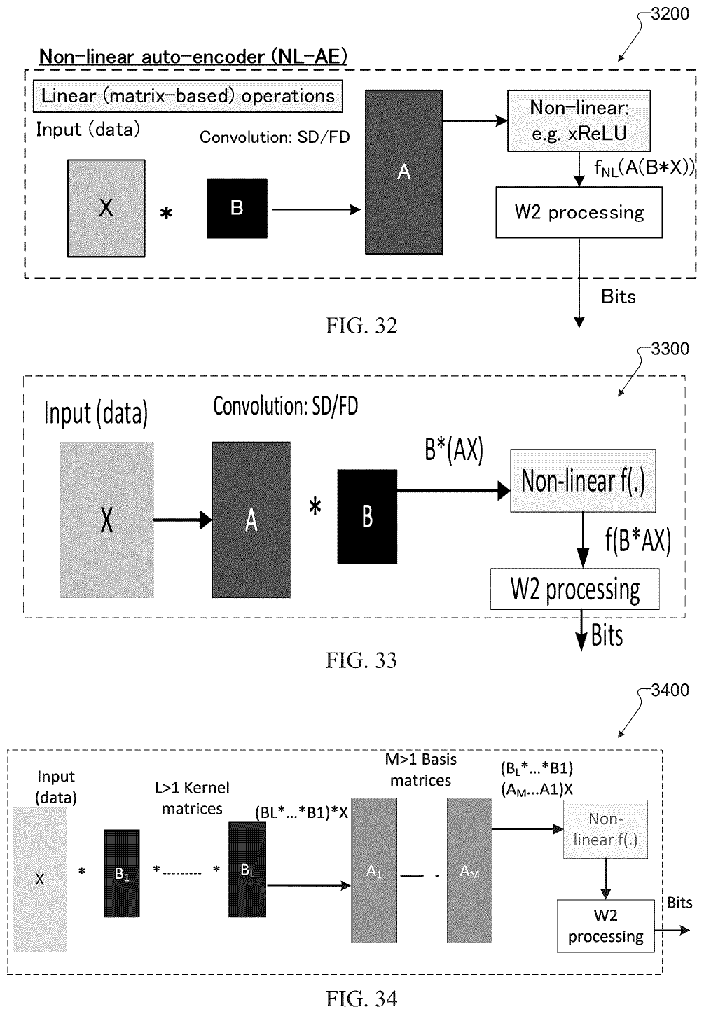

FIG. 32 illustrates an example NL-AE 3200 according to embodiments of the present disclosure. For example, any of the UEs 111-116 of FIG. 1, such as the UE 115, can be configured to use the NL-AE 3200. This example is for illustration only and other embodiments can be used without departing from the scope of the present disclosure.

In one example, the one-sided AE includes linear components such as convolution operation (*) or/and matrix multiplication, as well as at least one non-linear (NL) component (or activation function), as shown in FIG. 32, wherein the input X is convolved (or convoluted) in SD or/and FD using a kernel (basis) matrix B. The matrix B can be a two-dimensional (2D) matrix, or a pair B=(B_{row}, B_{col}) of one-dimensional (1D) vectors associated with row and column of the input. The output of the convolution operation B*X is then processed linearly via a matrix A whose output is passed to a non-linear activation function/block (e.g. ReLU). The output dimension is set according to the desired CSI compression (number of bits). The resultant f_{NL} (A (B*X)) coefficients are quantized via W2 processing block. This block can be according to the W2 quantization scheme of Rel-16 NR eType II codebook.

In one example, the activation function is a ReLU given by: f(x)=max (0, x). In one example, the activation function is a leaky ReLU (LReLU) given by: g(x)=max (αx, x) where α≤1. In one example, the activation function is a tan-hyperbolic (or hyperbolic tangent) given by: h(x)=tan h(x).

FIG. 33 illustrates an example NL-AE 3300 according to embodiments of the present disclosure. For example, any of the UEs 111-116 of FIG. 1, such as the UE 116, can be configured to use the NL-AE 3300. This example is for illustration only and other embodiments can be used without departing from the scope of the present disclosure.

Alternatively, in one example, as shown in FIG. 33 the convolution and matrix multiplication operations can be swapped. In the rest of the disclosure, the former (convolution followed by multiplication) is expected. The examples/embodiments however are general and apply to the latter (multiplication followed by convolution).

FIG. 34 illustrates an example NL-AE 3400 according to embodiments of the present disclosure. For example, the UE 116 of FIG. 3 can be configured to use the NL-AE 3400. This example is for illustration only and other embodiments can be used without departing from the scope of the present disclosure.

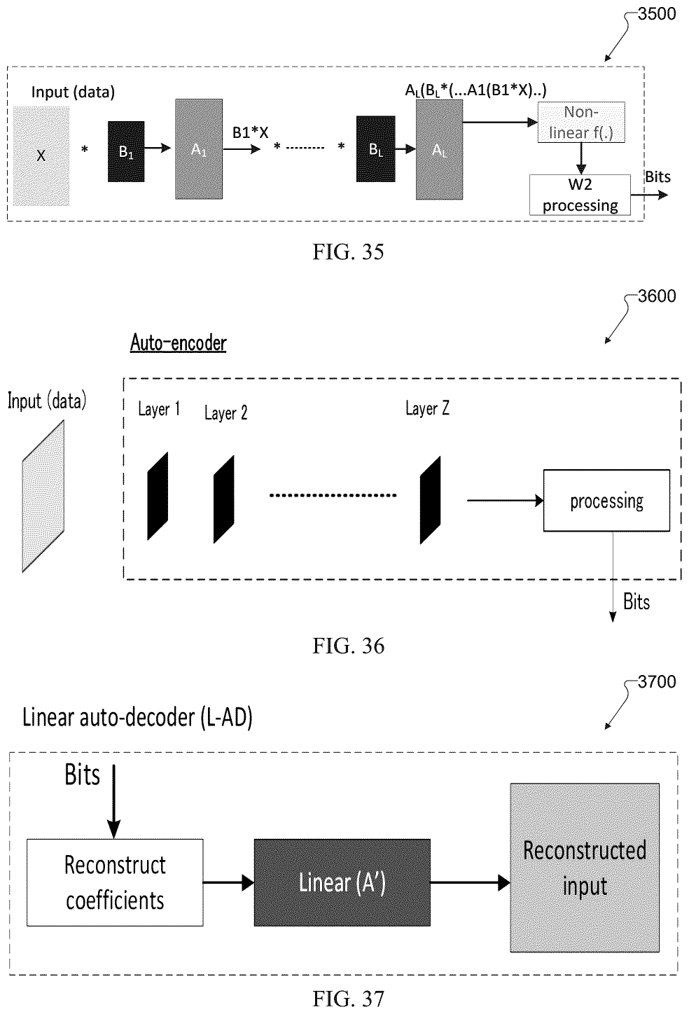

FIG. 35 illustrates an example NL-AE 3500 according to embodiments of the present disclosure. For example, any of the UEs 111-116 of FIG. 1, such as the UE 111, can be configured to use the NL-AE 3500. This example is for illustration only and other embodiments can be used without departing from the scope of the present disclosure.

In one example, an extension to multiple layers is shown in FIG. 34, wherein there are Kernel matrices B₁, . . . , B_{L} and basis matrices A₁, . . . , A_{L} of appropriate dimensions such that the overall Kernel or/and basis is a sequence of convolution operations B=B_{L}* . . . *B₁ followed by a multiplication A=A_{L}× . . . × A₁. In one example, L=1, M>1. In one example, L>1, M=1. In one example, L>1, M>1. In one example, L=M>1.

Another example is shown in FIG. 35, wherein L=M.

FIG. 36 illustrates an example one-sided/linear AE 3600 according to embodiments of the present disclosure. For example, any of the UEs 111-116 of FIG. 1, such as the UE 112, can be configured to use the one-sided/linear AE 3600. This example is for illustration only and other embodiments can be used without departing from the scope of the present disclosure.

In one example, the one-sided model can include Z≥1 layers, each layer is according to at least one of the examples described herein. An example is shown in FIG. 36.

In one embodiment, as shown in FIG. 19, a UE is configured to use a neural network (NN)-based two-sided model comprising an auto-encoder (AE) part and an auto-decoder (AD) part. The AE part of the model is used to determine a CSI, where the CSI is based on compression in at least one of SD, FD, and DD. The AE takes an input (data), e.g. eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW as input to the AD part of the model. The output of the AD part corresponds to a reconstructed CSI. In one example, the AE part is according to at least one or more examples described herein.

In one example, at least the AE part of the two-sided model used for CSI compression is downloadable (e.g. via RRC or broadcast message). The UE is configured to use the AE part of the two-sided model to compress CSI for reporting. The NW receives the compressed CSI and uses the AD part of the two-sided to perform necessary operations to reconstruct the CSI. In one example, the AE part of the two-sided model is according to one or more embodiments described herein. The AD part of the two-sided model includes at least one of the following.
A linear operation, for example, via at least one matrix V_{L}.
A non-linear (NL) operation, for example, via at least one NL function g_{NL} ( ).
A normalization operation, for example, via at least one matrix Vₙₒᵣₘ.

Let V₁ denote the operations performed by the AD on the received compressed CSI Y. In one example, Y=W₁X or f_{NL} (X) or Wₙₒᵣₘf_{NL} (X) or Wₙₒᵣₘf_{NL} (W₁X).

In one example, the AD part of the two-sided model includes a linear operation V_{L}. In this case, V₁=V_{L}Y.

In one example, the AD part of the two-sided model includes a non-linear operation gNL ( ) In this case, V₁=g_{NL} (Y).

In one example, the AD part of the two-sided model includes a normalization operation Yₙₒᵣₘ. In this case, V₁=Vₙₒᵣₘ Y.

In one example, the AD part of the two-sided model includes V_{L} and Yₙₒᵣₘ. In this case, V₁=Yₙₒᵣₘ V_{L}Y.

In one example, the AD part of the two-sided model includes V_{L} and g_{NL}. In this case, V₁=V_{L}g_{NL} (Y) Or g_{NL} (V_{L}Y).

In one example, the AD part of the two-sided model includes Yₙₒᵣₘ and g_{NL}. In this case, V₁=Yₙₒᵣₘg_{NL} (Y) or g_{NL} (YₙₒᵣₘY).

In one example, the AD part of the two-sided model includes V_{L}, Yₙₒᵣₘ and g_{NL}. In this case, V₁=Yₙₒᵣₘ V_{L}G_{NL} (Y) or Yₙₒᵣₘg_{NL} (V_{L}Y) or g_{NL} (Yₙₒᵣₘ V_{L}Y).

In one example, the AE part of the two-sided model (is downloadable) can be configured to the UE (e.g., the UE 116) via an RRC connection. As the UE connects (or moves) to a cell, the UE is provided with the corresponding AE-part of the two-sided model for the cell.

In one example, when the AE part of the two-sided model (is downloadable) is cell-specific, the trained AE-part model (codebook) can be configured to UEs within the cell via an information in the Broadcast channel, e.g. SIB1.

In one example, when the AE part of the two-sided model (is downloadable) is UE-specific, the trained AE-part model (codebook) can be configured to UEs via UE-specific RRC messages.

In one example, the trained AE part of the two-sided model (is downloadable) can be configured to UEs via a combination of cell-specific and UE-specific (e.g. SIBI and RRC) signaling. In one example, the cell-specific part of the configuration corresponds to a set/pool S of AE parts of two-sided models or at least one component of the AE part of the two-sided model. The UE-specific part selects/indicates a subset Sᵤ from the set S to a UE u. The subset Sᵤ can be different or same across UEs.

FIG. 37 illustrates an example L-AD 3700 according to embodiments of the present disclosure. For example, the network 130 and/or the BS 102 can be configured to utilize the L-AD 3700. This example is for illustration only and other embodiments can be used without departing from the scope of the present disclosure.

In one example, the AD part includes linear components such as a dense layer based on a matrix multiplication, as shown in FIG. 37, wherein the received bits are processed to reconstruct coefficients Y that are then linearly multiplied with a matrix A′ whose output (column) dimension is set according to the desired/target CSI. The output corresponds to the reconstructed input.

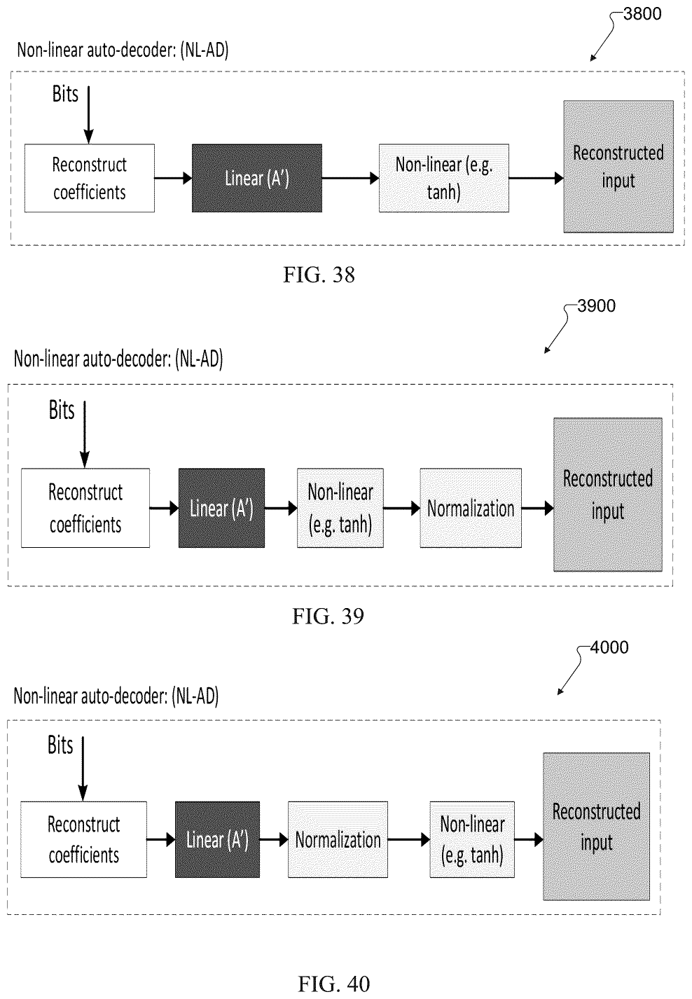

FIG. 38 illustrates an example NL-AD 3800 according to embodiments of the present disclosure. For example, the network 130 and/or the BS 103 can be configured to utilize the NL-AD 3800. This example is for illustration only and other embodiments can be used without departing from the scope of the present disclosure.

In one example, the AD part includes linear components such as a dense layer based on a matrix multiplication, as shown in FIG. 38, wherein the received bits are processed to reconstruct coefficients Y that are then linearly multiplied with a matrix A′ whose output is passed through a non-linear (NL) activation function (e.g. tanh). The output (column) dimension of the NL layer is set according to the desired/target CSI. The output corresponds to the reconstructed input \tilde{X}.

FIG. 39 illustrates an example NL-AD 3900 according to embodiments of the present disclosure. For example, the network 130 and/or the BS 101 can be configured to utilize the NL-AD 3900. This example is for illustration only and other embodiments can be used without departing from the scope of the present disclosure.

In one example, the AD part includes linear components such as a dense layer based on a matrix multiplication, as shown in FIG. 39, wherein the received bits are processed to reconstruct coefficients Y that are then linearly multiplied with a matrix A′ whose output is passed through a non-linear (NL) activation function (e.g. tanh) followed by a normalization layer. The output (column) dimension of the NL layer is set according to the desired/target CSI. The final output corresponds to the reconstructed input \tilde{X}.

FIG. 40 illustrates an example NL-AD 4000 according to embodiments of the present disclosure. For example, the network 130 and/or the BS 102 can be configured to utilize the NL-AD 4000. This example is for illustration only and other embodiments can be used without departing from the scope of the present disclosure.

In one example, as shown in FIG. 40, the AD part includes the same components as in AD3, except that order of NL and normalized layers are swapped.

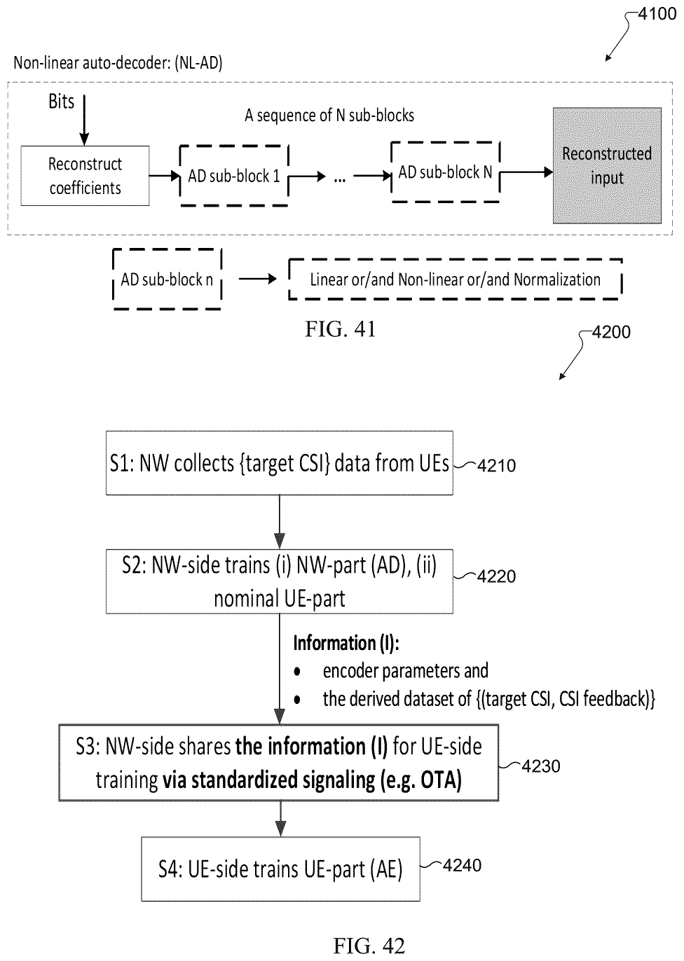

FIG. 41 illustrates an example NL-AD 4100 according to embodiments of the present disclosure. For example, the network 130 and/or the BS 103 can be configured to utilize the NL-AD 4100. This example is for illustration only and other embodiments can be used without departing from the scope of the present disclosure.

In one example, as shown in FIG. 41, the AD-part of the two-sided model can include N>1 sub-blocks n=1, . . . , N, each comprising at least one of linear, non-linear, and normalization layers in any order. Each sub-block is according to at least one of the examples herein.

In one embodiment, the model for CSI compression is one-sided, i.e., AD only. In one example, the AD part of the two-sided model is according to one or more embodiments described herein.

FIG. 42 illustrates a flowchart of an example procedure 4200 for UE-side training according to embodiments of the present disclosure. For example, procedure 4200 can be performed by the network 130 and/or the BS 102 and the UE 116 of FIG. 1. This example is for illustration only and other embodiments can be used without departing from the scope of the present disclosure.

The procedure begins in 4210, a NW collects (target CSI) data from UEs. In 4220, a NW-side trains (i) a NW-part (AD) and (ii) a nominal UE-part. In 4230, the NW-side shares information (I) for UE-side training via standardized signaling (e.g., over the air (OTA)). In 4240, a UE-side trains the UE-part (AE).

In one embodiment, the two-sided model procedure is as shown in FIG. 42. In step S1, the NW-side collects a dataset comprising target CSI (e.g. eigenvectors or channel measurements determined based on NZP CSI-RS measurements). The dataset can be acquired at the NW based on the CSI report from the UE, or via a dedicated channel from an entity to the NW. The entity can be an OTT (over-the-top) server or an O-DU or a O-CU or O-RU or an entity in a protocol stack. In step S2, the NW-side trains the AD-part of the two-sided model expecting a reference nominal AE-part (at the UE) of a reference two-sided model. After (based on) the AD model training, the NW transfers an information (I) to a UE. The information (I) can include (i) parameter(s) of the AE-part of the two-sided model, or/and (ii) a ‘derived’ dataset for the UE-side to use for inference/training based on the AE-part. The ‘derived’ dataset can be a set of pairs {(target CSI, CSI feedback)} where the CSI feedback is the output of the nominal AE model expected while training the AD-part. Based on the received information (I), the UE-side trains the AE-part of the two-sided model. This training can assume a reference nominal AD-part (at the NW) of a reference two-sided model. The model training at the NW or the UE can be on online (on device or on NW) or offline (e.g. via a respective OTT (over-the-top) server of UE or NW, or an O-DU or a O-CU or O-RU or an entity in a protocol stack.).

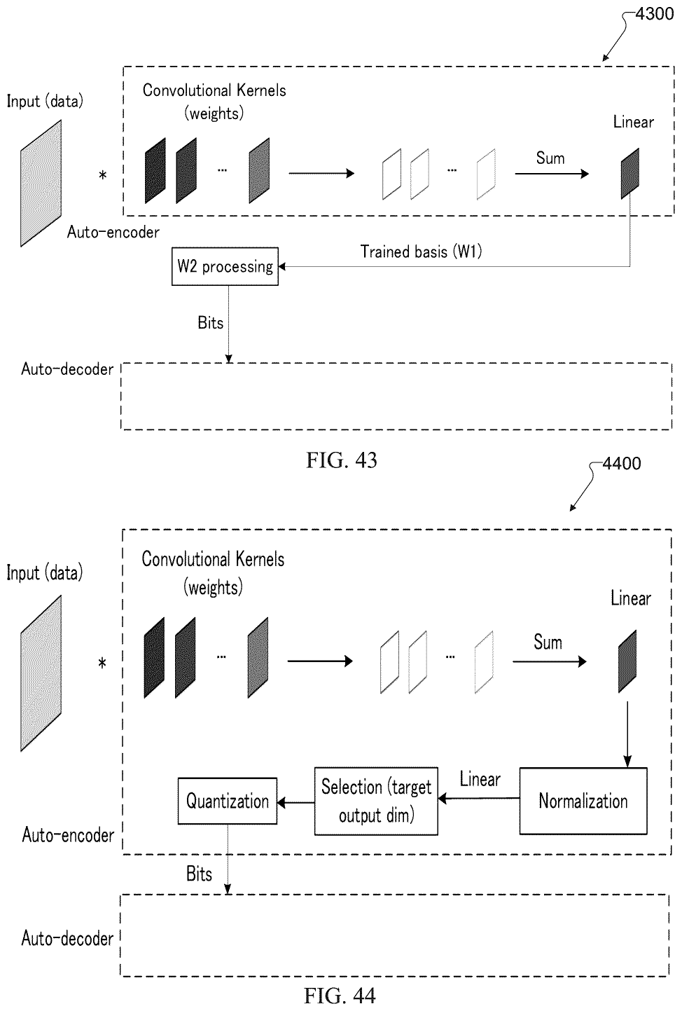

FIG. 43 illustrates an example single layer CNN 4300 with multiple output channels according to embodiments of the present disclosure. For example, single layer CNN 4300 can be implemented by any of the UEs 111-116 of FIG. 1. This example is for illustration only and other embodiments can be used without departing from the scope of the present disclosure.

In one embodiment, as shown in FIG. 43, a UE is configured to use a neural network (NN)-based auto-encoder (AE) model to determine a CSI, where the CSI is based on compression in at least one of SD, FD, and DD. The AE takes an input (data), e.g. eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI. The model includes a single-layer basis (W1), CNN with K₁ Kernels or output channels, where K₁>1. In FIG. 43, the channels are shown in different colors.

FIG. 44 illustrates an example single layer CNN 4400 according to embodiments of the present disclosure. For example, single layer CNN 4400 can be implemented by any of the UEs 111-116 of FIG. 1, such as the UE 116. This example is for illustration only and other embodiments can be used without departing from the scope of the present disclosure.

In one embodiment, as shown in FIG. 44, a UE is configured to use a neural network (NN)-based auto-encoder (AE) model to determine a CSI, where the CSI is based on compression in at least one of SD, FD, and DD. The AE takes an input (data), e.g. eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI. The model includes a single-layer basis (W1), CNN with K₁ Kernels or output channels and additional linear processing (modules), where K₁≥1, the additional processing can be (i) a normalization layer or/and (ii) a selection layer according to a target output payload.

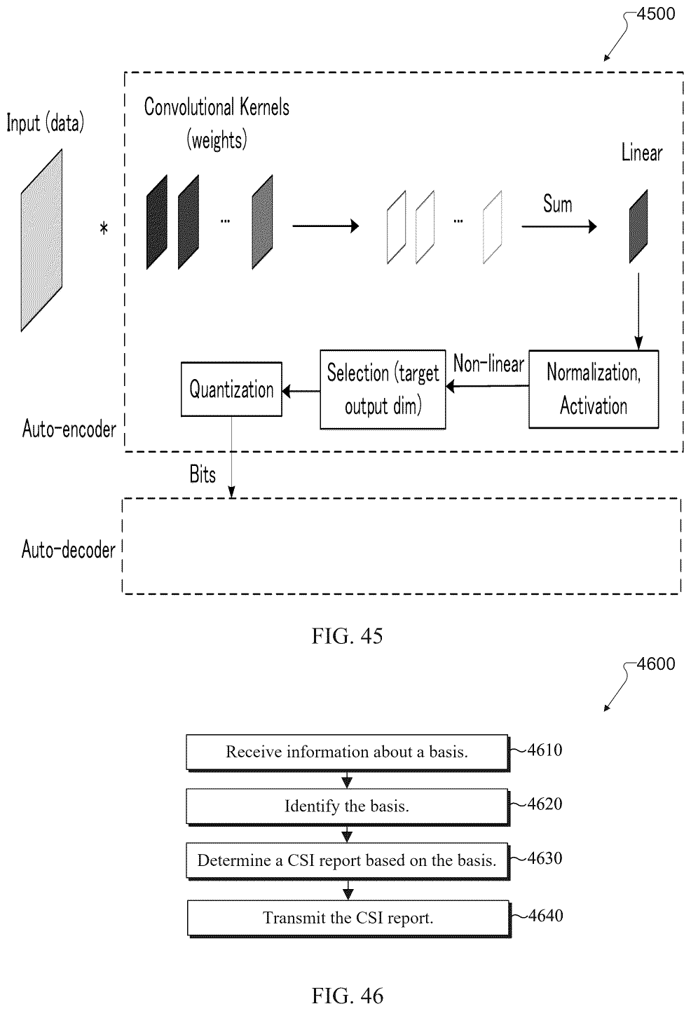

FIG. 45 illustrates an example single layer CNN with (non-linear) activation 4500 according to embodiments of the present disclosure. For example, single layer CNN with (non-linear) activation 4500 can be implemented by the UE 116 of FIG. 3. This example is for illustration only and other embodiments can be used without departing from the scope of the present disclosure.

In one embodiment, as shown in FIG. 45, a UE is configured to use a neural network (NN)-based auto-encoder (AE) model to determine a CSI, where the CSI is based on compression in at least one of SD, FD, and DD. The AE takes an input (data), e.g. eigenvectors of DL channel measurements (via CSI-RS) or DL channel estimate itself, performs operations (linear or/and non-linear) and outputs a bit sequence which is transmitted by the UE as part of the CSI report. The bit sequence is used by the NW to reconstruct the CSI. The model includes a single-layer basis (W1), CNN with K₁ Kernels or output channels and additional linear and non-linear processing (modules), where K₁≥1, the additional processing can be (i) a normalization layer or/and (ii) a selection layer according to a target output payload. The non-linear processing can be according to at least one activation function, as described herein.

In one embodiment, the model is a multi-layer CNN, each with K₁ Kernels or output channels, where K₁≥1, each layer according to one or more embodiments described herein. In one example, K₁ is fixed, e.g. K₁=1. In one example, K₁ is configurable (e.g. via RRC, or SIB1).

In one embodiment, the model is a multi-layer CNN, layer n with Kₙ Kernels or output channels, where Kₙ≥1, n=1, . . . , N, N equals number of layers, and each layer is according to one or more embodiments described herein. In one example, Kₙ is fixed. In one example, Kₙ is configurable (e.g. via RRC, or SIB1).

In one embodiment, the model is a multi-layer CNN, layer n with Kₙ Kernels or output channels, where Kₙ≥1, n=1, . . . , N, N equals number of layers, and each layer is according to one or more embodiments described herein. In one example, Kₙ is fixed. In one example, Kₙ is configurable (e.g. via RRC, or SIB1).

In one example, each layer corresponds to (or is associated with) a dominant eigenmode (eigenvector or singular vector) of the channel or channel covariance matrix, where the eigenmode is either separate (i.e. 1D) for SD and FD, or joint (i.e. 2D) across SD and FD.

In one example, each layer corresponds to (or is associated with) a principle component, i.e., determined based on principal component analysis (PCA), of the channel or channel covariance matrix, where the principle component is either separate (i.e. 1D) for SD and FD, or joint (i.e. 2D) across SD and FD.

In one example, the input data includes a separate dataset for each principle component. In one example, the input data includes one/joint dataset. The UE extracts per layer (layer 1, layer 2, . . . ) information from the joint dataset. The information about layer 2 can be based on (or after) subtracting layer 1 information from the input dataset.

FIG. 46 illustrates an example method 4600 performed by a UE in a wireless communication system according to embodiments of the present disclosure. The method 4600 of FIG. 46 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 4600 is for illustration only and other embodiments can be used without departing from the scope of the present disclosure.

The method 4600 begins with the UE receiving information about a basis (4610). For example, in 4610, the basis is a trained basis when the UE is capable of supporting the trained basis or a fixed DFT basis when the UE is not capable of supporting the trained basis. The trained basis is trained using data. In various embodiments, the UE transmits capability information indicating whether the UE is capable of supporting the trained basis. In various embodiments, the UE receives the trained basis via higher layer RRC message or a SIB1.

The UE then identifies the basis (4620). The UE then determines a CSI report based on the basis (4630). For example, in 4630, the basis, the data, and the CSI report are associated with P ports and N_{SB} SBs, where P and N are greater than 1. In various embodiments, the CSI report includes a CQI that is based on a precoding matrix. In some embodiments, the precoding matrix is an input of an encoder model and an output of the encoder model is the CSI report. In some embodiments, the precoding matrix is an output of a decoder model and an input of the decoder model is the CSI report. In some examples, the decoder model is fixed or configured via a higher layer RRC message or a SIB1. The UE then transmits the CSI report (4640).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive information about a basis, wherein the basis is:
a trained basis when the UE is capable of supporting the trained basis, or
a fixed discrete Fourier transform (DFT) basis when the UE is not capable of supporting the trained basis; and
a processor operably coupled to the transceiver, the processor configured to:
identify the basis, and
determine a channel state information (CSI) report based on the basis,
wherein the transceiver is further configured to transmit the CSI report,
wherein the trained basis is trained using data, and
wherein the basis, the data, and the CSI report are associated with P ports and N_{SB} subbands (SBs), where P and N_{SB} are greater than 1.

2. The UE of claim 1, wherein the transceiver is further configured to transmit capability information indicating whether the UE is capable of supporting the trained basis.

3. The UE of claim 1, wherein the transceiver is further configured to receive the trained basis via higher layer radio resource control (RRC) message or a system information block 1 (SIB1).

4. The UE of claim 1, wherein the CSI report includes a channel quality indicator (CQI) that is based on a precoding matrix.

5. The UE of claim 4, wherein:
the precoding matrix is an input of an encoder model; and
an output of the encoder model is the CSI report.

6. The UE of claim 4, wherein:
the precoding matrix is an output of a decoder model, and
an input of the decoder model is the CSI report.

7. The UE of claim 6, wherein the decoder model is fixed or configured via a higher layer radio resource control (RRC) message or a system information block (SIB1).

8. A base station (BS), comprising:
a processor; and
a transceiver operably coupled to the transceiver, the processor configured to
transmit information about a basis to a user equipment (UE), wherein the basis is:
a trained basis when the UE is capable of supporting the trained basis, or
a fixed discrete Fourier transform (DFT) basis when the UE is not capable of supporting the trained basis; and
receive a channel state information (CSI) report based on the basis,
wherein the trained basis is trained using data, and
wherein the basis, the data, and the CSI report are associated with P ports and N_{SB} subbands (SBs), where P and N_{SB} are greater than 1.

9. The BS of claim 8, wherein the transceiver is further configured to receive capability information indicating whether the UE is capable of supporting the trained basis.

10. The BS of claim 8, wherein the transceiver is further configured to transmit the trained basis via higher layer radio resource control (RRC) message or a system information block 1 (SIB1).

11. The BS of claim 8, wherein the CSI report includes a channel quality indicator (CQI) that is based on a precoding matrix.

12. The BS of claim 11, wherein:
the precoding matrix is an input of an encoder model; and
an output of the encoder model is the CSI report.

13. The BS of claim 11, wherein:
the precoding matrix is an output of a decoder model, and
an input of the decoder model is the CSI report.

14. The BS of claim 13, wherein the decoder model is fixed or configured via a higher layer radio resource control (RRC) message or a system information block (SIB1).

15. A method performed by a user equipment (UE), the method comprising:
receiving information about a basis, wherein the basis is:
a trained basis when the UE is capable of supporting the trained basis, or
a fixed discrete Fourier transform (DFT) basis when the UE is not capable of supporting the trained basis;
identifying the basis;
determining a channel state information (CSI) report based on the basis; and
transmitting the CSI report,
wherein the trained basis is trained using data, and
wherein the basis, the data, and the CSI report are associated with P ports and N_{SB} subbands (SBs), where P and N_{SB} are greater than 1.

16. The method of claim 15, further comprising transmitting capability information indicating whether the UE is capable of supporting the trained basis.

17. The method of claim 15, wherein receiving information about the basis comprises receiving the trained basis via higher layer radio resource control (RRC) message or a system information block 1 (SIB1).

18. The method of claim 15, wherein the CSI report includes a channel quality indicator (CQI) that is based on a precoding matrix.

19. The method of claim 18, wherein:
the precoding matrix is an input of an encoder model; and
an output of the encoder model is the CSI report.

20. The method of claim 18, wherein:
the precoding matrix is an output of a decoder model, and
an input of the decoder model is the CSI report.
